(19) United States
(12) Patent Application Publication
(10) Pub. No.: US 2007/0112738 A1
(43) Pub. Date: May 17, 2007

(54) Displaying User Relevance Feedback for Search Results

(75) Inventor: E. G. Livaditis, Vienna, VA (US)

Correspondence Address: W. Karl Renner, FISH & RICHARDSON P.C., P.O.BOX 1022, MINNEAPOLIS, MN, 55440-1022, US

(73) Assignee: AOL LLC, Dulles, VA (US)

(21) Appl. No.: 11/382,556

(22) Filed: May 10, 2006

Related U.S. Application Data
(60) Provisional application No. 60/735,881, filed on Nov. 14, 2005.

(51) Int. Cl. G06F 17/30

(52) U.S. Cl. 707/3

(57) ABSTRACT

A query submitter may submit a search query. In response, the query submitter may be provided with search results and user feedback related to the search results. The user feedback may include a relevancy rating of the search result. The relevancy rating may be derived from feedback received from a user, other than the query submitter, and may reflect how the other user perceived the relevancy of the search result to the search query. The other user may be determined to be known to the query submitter or the other user and the query submitter may share one or more attributes.

### CROSS REFERENCE TO RELATED APPLICATIONS

This application claims the benefit of U.S. Provisional Application No. 60/735,881, filed Nov. 14, 2005 and titled DISPLAYING USER FEEDBACK FOR SEARCH RESULTS, which is incorporated by reference in its entirety.

### TECHNICAL FIELD

This description relates to providing user feedback with search results.

### BACKGROUND

Conventional search engine interfaces present search results returned by a search engine. Each search result may be presented with a title that serves as a link to content corresponding to the search result. The search result also may include a summary of the content corresponding to the search result, as well as an indication of the location of the content and away of accessing pages related to the search result.

The user of the conventional search engine interface references the title and summary presented in the search result while deciding whether to access the content associated with the search result. The summary and title may not accurately or completely describe the content, yet the user may find something included in the summary and title, or missing from the summary and title, that leads the user to or away from accessing the content.

### SUMMARY

In a first general aspect, user feedback for a search result is displayed. A search query is received from a query submitter. A relevancy rating that is derived from feedback received from a user other than the query submitter and that reflects how the other user perceived relevancy of the search result to the search query is accessed.

With respect to the first general aspect, implementations may include one or more of the following. For example, the accessed relevancy for a search result may be compared with relevancy ratings related to other search results. The search results may be sorted based on the comparison. The relevancy rating may be displayed for user perception in the form of raw, numeric or symbolic data.

Relevancy of the search result to the search query may be determined based on relevancy of the search result to words related to the search query. Relevancy of the search result to the search query may be determined based on relevancy of words that are related to words appearing in the search result to words in the search query. Relevancy of the search result to the search query may be determined based on relevancy of words that are related to words appearing in the search result to words related to words in the search query.

The relevancy rating may be accessed if it is derived from feedback received from a user who belongs to a subset of user identities determined to be known to the query submitter. User identities may be determined to be known to the query submitter if the user identities is within a particular degree of separation from the query submitter, the user identities exist in a contact list, a co-user list or a white list belonging to the query submitter, or the user identities share attributes with the query submitter.

In a second general aspect, relevancy feedback related to a search query is received. A search result is provided responsive to a search query submitted by a feedback-providing user. Relevancy feedback that reflects how the feedback-providing user perceived relevancy of the search result to the search query is solicited and received. The relevancy feedback is aggregated with other relevancy feedback received for the same search result provided in response to a related search query.

With respect to the second general aspect, implementations may include one or more of the following. For example, the related search query may include a search query that is identical to the search query submitted by the feedback-providing user. The related search query may include a search query having at least one word in common with the search query submitted by the feedback-providing user The related search query may include a search query having the same meaning as the search query submitted by the feedback-providing user. The related search query may include a search query related to the same topic as the search query submitted by the feedback-providing user.

Receiving relevancy feedback may include enabling the feedback-providing user to rate the relevancy of the search result to the search query via a user interface enabled to display the search result and receive the relevancy rating. The relevancy rating may be a numeric ranking, a selection of a pre-determined comment, or creation of a user-created comment related to the relevancy of the search result to the search query.

Aggregating the relevancy feedback with other relevancy feedback received for the same search result provided in response to a related search query may include creating and storing a relevancy feedback table. The relevancy feedback table may include a search query, at least one related search query, at least one search result that is responsive to the search query and relevancy feedback for the search result. The relevancy table also may include an identity of a feedback-providing user who provided the relevancy feedback for the search result and a list of attributes related to the feedback-providing user.

Implementations of any of the techniques described may include a method or process, an apparatus or system, or computer software on a computer-accessible medium. The details of particular implementations are set forth below. Other features will be apparent from the description and drawings, and from the claims.

### DESCRIPTION OF DRAWINGS

FIGS. 1A-1E are illustrations of conventional search engine interfaces for presenting search results returned by a search engine.

FIG. 2 is a block diagram of a communications system capable of providing user feedback with search results.

FIGS. 3A-3E are illustrations of exemplary updated search engine interfaces for providing additional information describing characteristics of content corresponding to search results presented to a user in a search engine interface.

FIG. 4 is a block diagram of a search engine that visits web pages to gather information that may be helpful in returning search results that match entered search criteria.

FIGS. 5A-5F are flow charts of characteristic identification processes for identifying characteristics of content corresponding to one or more search results.

FIG. 6 is a flow chart of a search result display process for displaying search results along with descriptions of characteristics of content corresponding to the search results.

FIGS. 7A-7B are illustrations of exemplary search engine interfaces for including displaying search results that have been sorted and filtered based on the availability of content corresponding to the search results.

FIGS. 8A-8C are flow charts of processes for sorting and/or filtering search results for display on a search engine interface.

FIG. 9 is a flow chart of a process for providing user feedback with search results received in response to a user-entered search query.

FIG. 10 is a flow chart of a process for receiving user feedback for a search result and storing the user feedback in search-result information.

FIG. 11 is an exemplary database for storing search-result information.

FIG. 12 is an illustration of an exemplary graphical user interface for providing user feedback for a search result related to a search query.

FIG. 13 is a flow chart of a process for presenting user feedback for a search result related to a search query based on whether the user feedback was provided by a person related to a searching user.

FIG. 14 is a flow chart of a process for determining if a feedback-providing user is related to a searching user.

FIG. 15 is an illustration of an exemplary graphical user interface depicting search results provided with user feedback.

FIG. 16 is a flow chart for a process for creating, maintaining and using a list of people known to a user.

FIG. 17 is a flow chart of a process for inferring people within a certain number of degrees of separation from a user as known to the user.

Like reference symbols in the various drawings indicate like elements.

### DETAILED DESCRIPTION

Search results may be provided to a user in response to a search query. For example, a user who is seeking information on the television show “Gilmore Girls,” may enter the phrase “Gilmore Girls” into the search field of a search engine being shown in a browser. In response, the search engine may provide the user with search results related to “Gilmore Girls.” However, providing the search results alone may cause the user difficulty in determining which of the search results, if any, may be the most helpful to the user in providing the information the user seeks.

Techniques are described for providing feedback with search results. The feedback may assist the user in determining which of the search results may be the most helpful or the most enjoyable to the user. Furthermore, feedback may be provided with search results based on whether a user who has provided the feedback (who may be referred to as “a feedback-providing user”) is known to the user seeking the information (who may be referred to as a user or a “searching user”). For example, if a searching user is presented with feedback for the search results provided in response to the user's search for “Gilmore Girls,” it may be more helpful to the searching user if the feedback is from a person known to the searching user. More particularly, because the searching user knows the feedback-providing user, the searching user already may have a basis for determining how much weight to give the feedback provided by the feedback-providing user and thus, the feedback may be even more useful to the searching user. For example, a searching user may be provided with two search results, where each search result includes feedback from a feedback-providing user who is known to the searching user. If one of the feedback-providing users is a fellow Gilmore Girls fan, the searching user may give weight to the feedback-providing user's comments about the search result. In contrast, if the other feedback-providing user does not own a television set, the searching user may give less weight to feedback provided by this particular feedback-providing user.

Techniques also are provided for including both quantitative and qualitative feedback with search results. For example, quantitative feedback may include a percentage of people who have viewed the search result or an indication of the search result (e.g., the percentage of people who have viewed the link to the search result, but who have not clicked on the link to visit the web site indicated by the search result). The people may be people known to the searching user, members of an Internet Service Provider of which the searching user is also a member, or members of the general public. Quantitative user feedback also may include a ranking of relevancy of the search result to the search query, quality of the search result itself (e.g., an indication of the general quality of content related to the search result) or some other metric related to the search result. Qualitative feedback may include, for example, comments provided by a feedback-providing user. The comments may be chosen from a list of pre-determined comments or created by the feedback-providing user. The qualitative user feedback also may include an indication of relevancy of the search result to the search query or content quality related to the search result. In some implementations, qualitative and quantitative feedback may be aggregated into a single item of user feedback.

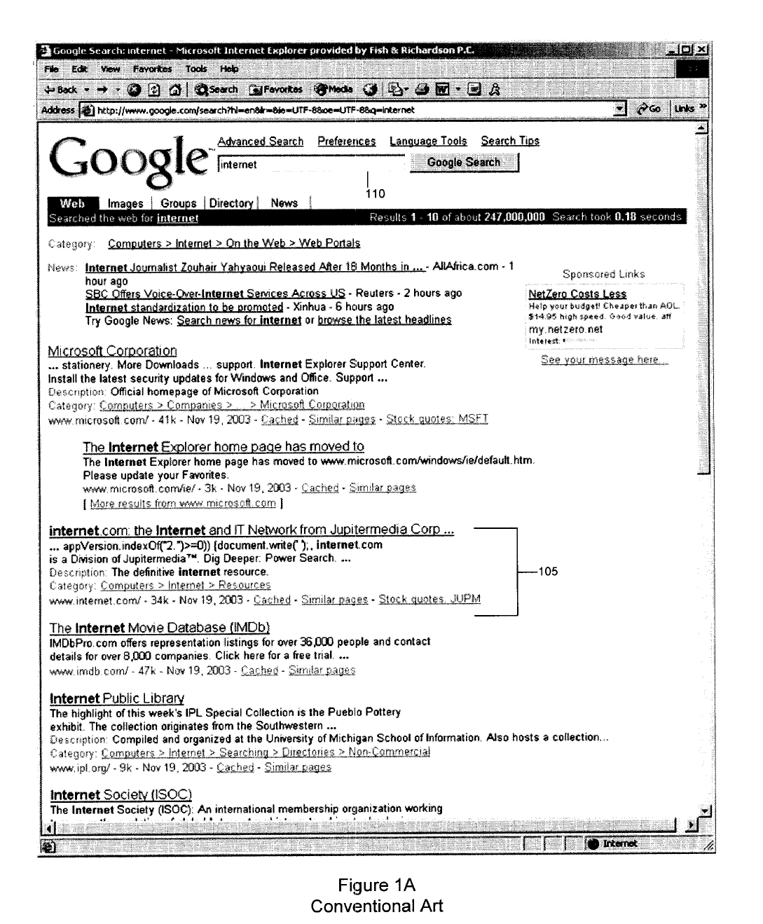

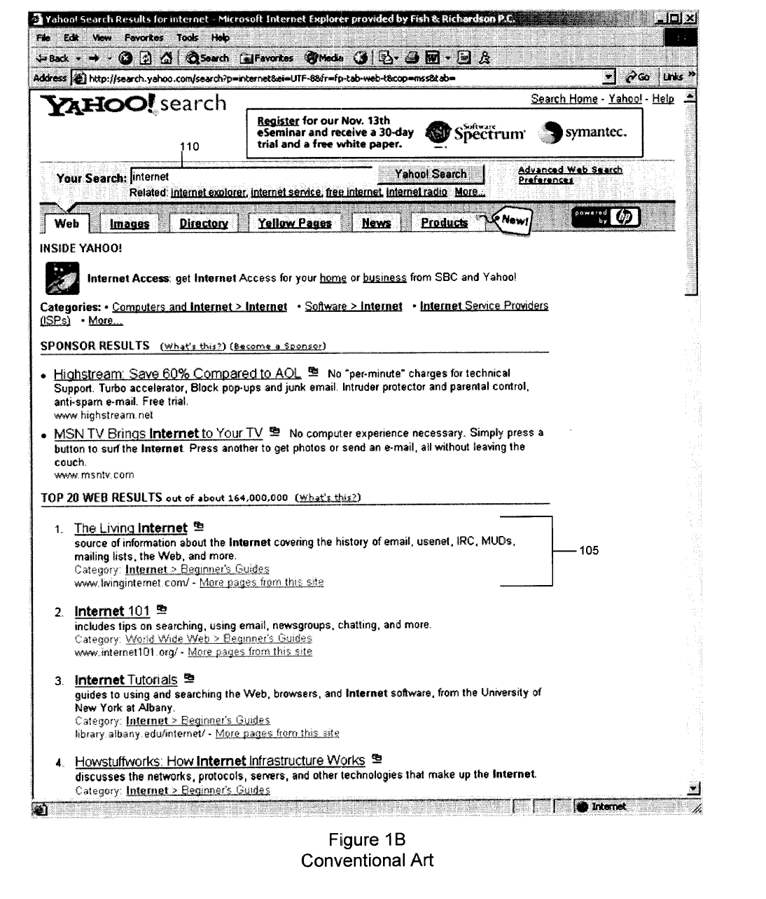

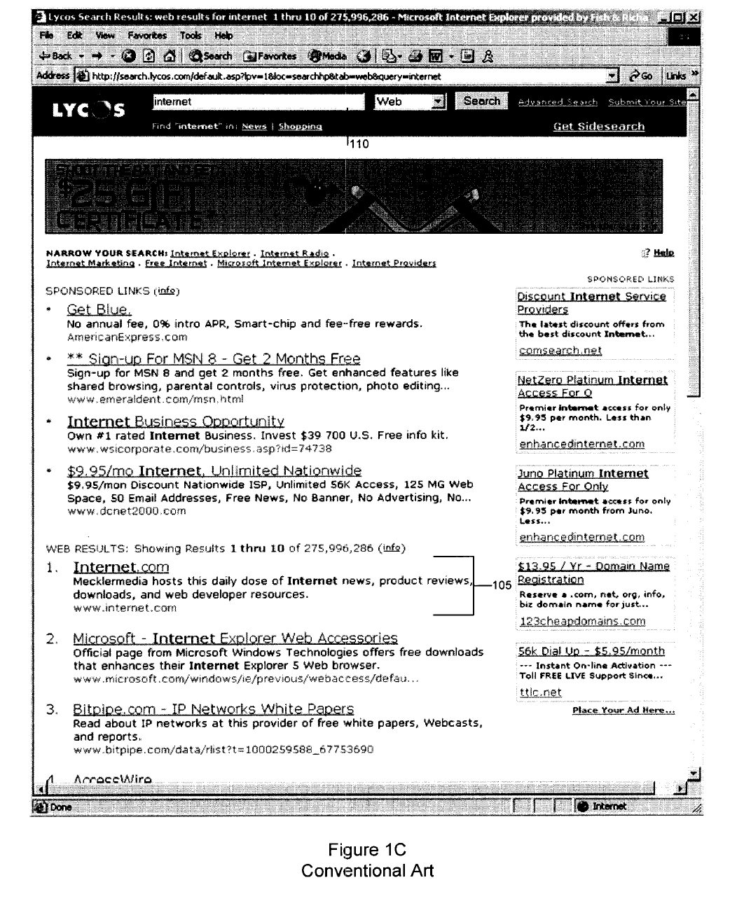

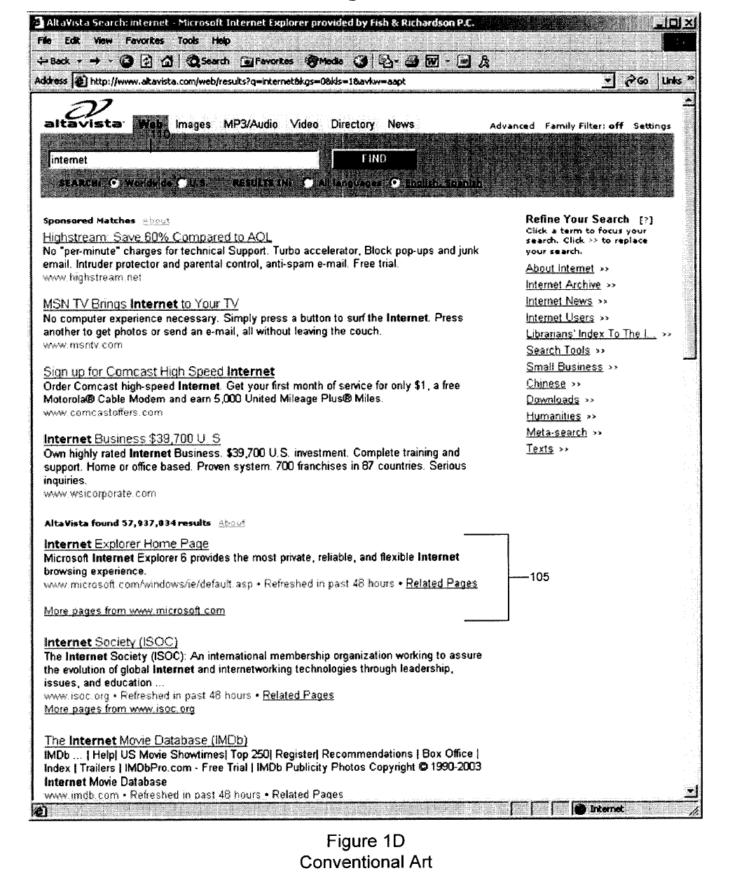

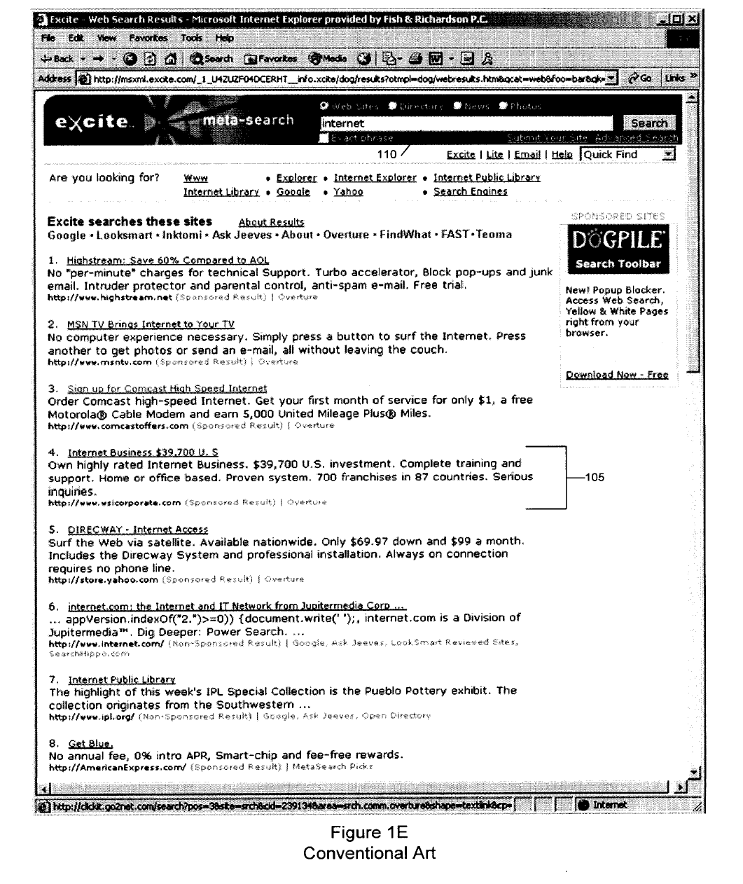

Referring to FIGS. 1A-1E, conventional search engine interfaces present search results returned by a search engine. For example, one or more search results 105 may be returned by a search engine to match search criteria 110 entered by a user of the conventional search engine interface 100. Each search result 105 may be presented with a title that serves as a link to content corresponding to the search result. The search result 105 also may include a summary of the content corresponding to the search result, as well as an indication of the location of the content and a way of accessing pages related to the search result 105.

The user of the conventional search engine interface 100 references the summary and title presented in the search result 105 while deciding whether to access the content associated with the search result. The summary, for example, may not accurately or completely describe the content, yet the user may find something included in the summary, or missing from the summary, that leads the user to or away from accessing the content.

By supplementing the content summary with additional information regarding the content, such as, for example, user feedback, the user may be better able to determine whether access is appropriate or desirable. For example, the user may be provided with information enabling a quick determination of whether the content corresponding to the search result 105 is unavailable, is inappropriate for minors, includes advertisements, includes or lacks multimedia content, has an unwanted file type, originates from an unwanted source, has not been viewed by people known to the user, or whether positive or negative user feedback has been provided (by a person known to the user or by others) for the content of a search result. A better indication of the content associated with the search results may prevent the user from accessing unwanted content so as to enable the user to more quickly access the content sought by the user.

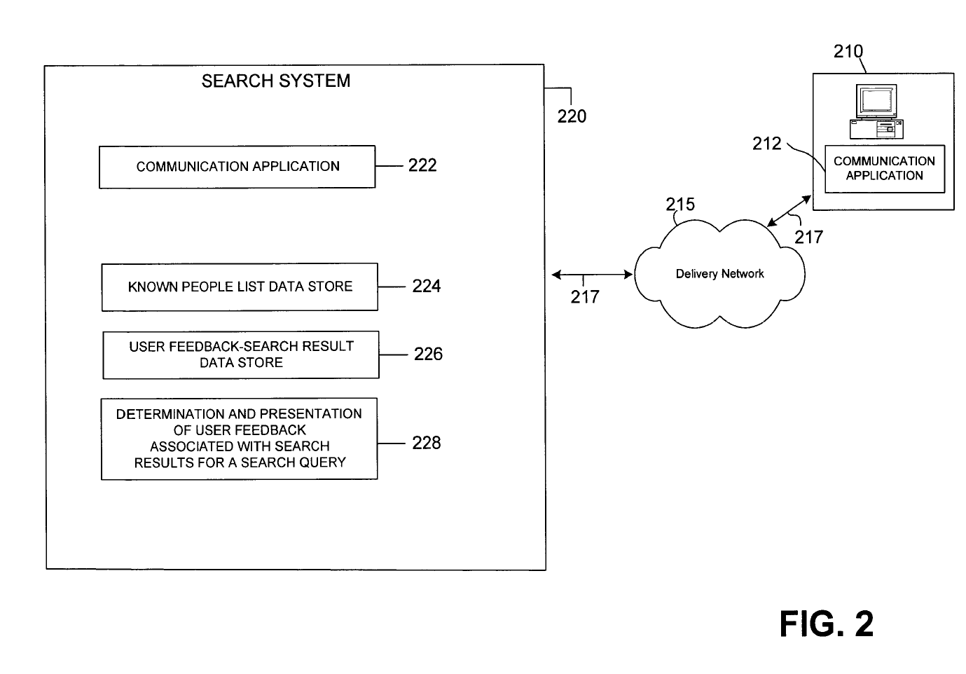

FIG. 2 is a block diagram 200 of a communications system capable of providing user feedback with search results. More particularly, the communications system 200 is capable of delivering and exchanging messages between a client system 210 and a search system 220 through a delivery network 215 to provide qualitative and quantitative user feedback from people who are known to a user who has requested the search results by entering a search query. A search system also may be referred to as a search engine.

Each of the client system 210 and the search system 220 may be a general-purpose computer (e.g., a personal computer, a desktop computer, or a laptop computer) capable of responding to and executing instructions in a defined manner. Other examples of the client system 210 and the search system 220 include a special-purpose computer, a workstation, a server, a device, a component, other physical or virtual equipment or some combination thereof capable of responding to and executing instructions. The client system 210 also may be a personal digital assistant (PDA), a communications device, such as a mobile telephone, or a mobile device that is a combination of a PDA and communications device.

The client system 210 also includes a communication application 212 and is configured to use the communication application 212 to establish a communication session with the search system 220 over the delivery network 215. The communication application 212 may be, for example, a browser or another type of communication application that is capable of accessing the search system 220. In another example, the communication application 212 may be a client-side application configured to communicate with the search system 220. The client system 210 is configured to send to the search system 220 requests for search results (e.g., a search query) and user feedback related to the search results. The client system 210 also is configured to receive search results and related user feedback from the search system 220 and to present the received search results and user feedback to a user.

The delivery network 215 provides a direct or indirect communication link between the client system 210 and the search system 220, irrespective of physical separation. Examples of a delivery network 215 include the Internet, the World Wide Web, WANs, LANs, analog or digital wired and wireless telephone networks (e.g., PSTN (“Public Switched Telephone Network”), ISDN (“Integrated Services Digital Network”), and DSL (“Digital Subscriber Line”) including various forms of DSL such as SDSL (“Single-line Digital Subscriber Line”), ADSL (“Asymmetric Digital Subscriber Loop), HDSL (“High bit-rate Digital Subscriber Line”), and VDSL (“Very high bit-rate Digital Subscriber Line)), radio, television, cable, satellite, and/or any other delivery mechanism for carrying data.

The delivery network 215 includes communication pathways 217 that enable the client system 210 and the search system 220 to communicate with the delivery network 215. Each of the communication pathways 217 may include, for example, a wired, wireless, virtual, cable or satellite communications pathway.

The search system 220 may receive instructions from, for example, a software application, a program, a piece of code, a device, a computer, a computer system, or a combination thereof, which independently or collectively direct steps, as described herein. The search system 220 includes a communication application 222 that is configured to enable the search system 220 to communicate with the client system 210 through the delivery network 215.

The search system 220 may be a host system, such as an Internet service provider that provides a search service to subscribers. In another example, the search system 220 may be a system that hosts a web site that provides search services to the general public.

In general, the search system 220 is configured to provide search results and related user feedback in response to a user-entered search query. In some implementations, the search system 220 may be configured to provide the user feedback for the search results based on whether the user feedback was provided by a person known to the searching user.

More particularly, the search system 220 includes a data store 224 configured to store a list of people known to a particular user. More particularly, the data store 224 may include identifiers, such as, for example, one or more screen names, related to users who are known to a particular user. The known people list may be generated, updated, or deleted by explicit or implicit actions of the user, as described in more detail below, and then stored in data store 224 upon any change.

The search system 220 also includes a user feedback-search result data store 226. Data store 226 is configured to store user feedback information that has been associated with a particular search result. Furthermore, a search result stored in data store 226 may be further associated with at least one search query that may cause the search result to be generated. Data store 226 also may be configured to store a cached copy of a search result (e.g., a cached copy of a website indicated by the search result). Thus, if a search result is no longer available for some reason, a user may access the cached copy of the search result when it is provided in response to a search query.

The known people list data store 224 and the user feedback-search result data store 226 may be stored in persistent or non-volatile storage, though this need not necessarily be so. For example, user feedback for a particular search result may be stored only in memory, such as random access memory, of the search system. Alternatively, the known people list data store 224 and the user feedback-search result data store 226 may be stored at client system 210 and accessed by search system 220 as needed.

The search system also includes code segments 228 configured to determine and present user feedback associated with search results for a search query. More particularly, code segments 228, when executed, may cause the search system to receive search results generated in response to a search query. In response, the search system may request user feedback related to the received search results from data store 226. The search system also may receive an indication of a searching user who requested the provided search results. In this configuration, the search system may access the known people list in data store 224 to determine if user feedback provided for the received search results has been provided by a feedback-providing user known to the searching user. The code segments 228 may present the search results and associated user feedback to a searching user based on whether the feedback was provided by a person known to the searching user. Alternatively, or additionally, user feedback that was not provided by people known to the searching user also may be provided to the searching user with the search results. If the search result is unavailable, the search system may provide a cached version of the search result if one has been stored in data store 226.

Search Result Content Characteristics Provided With Search Results

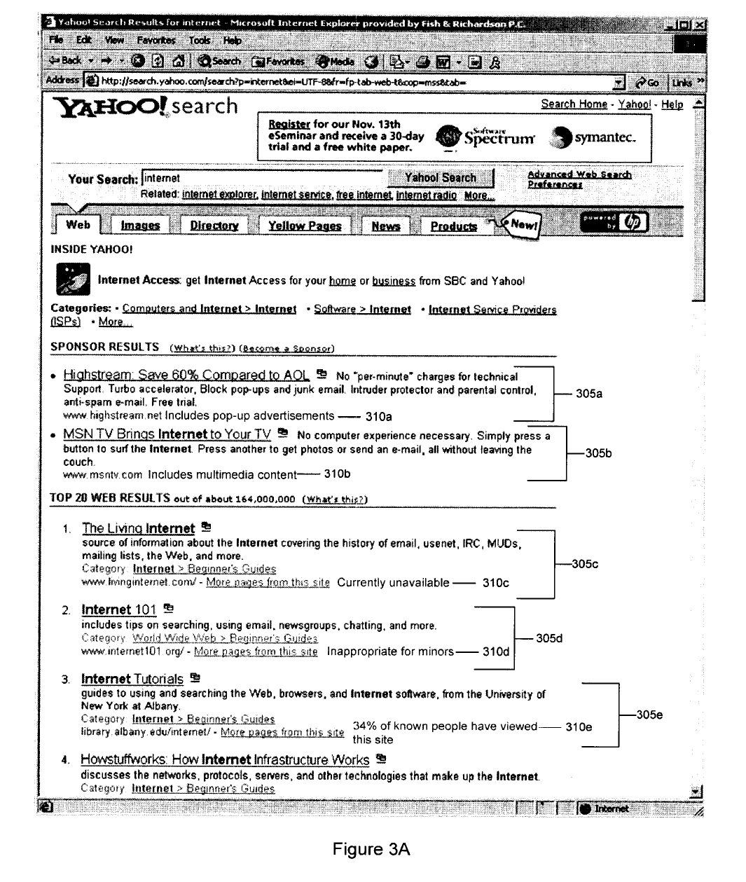

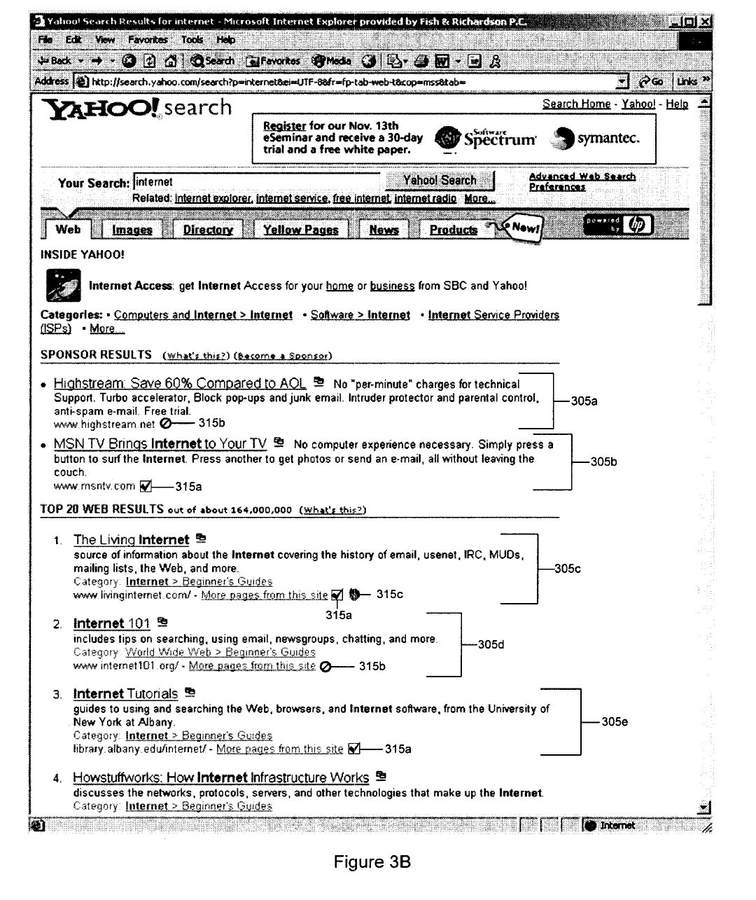

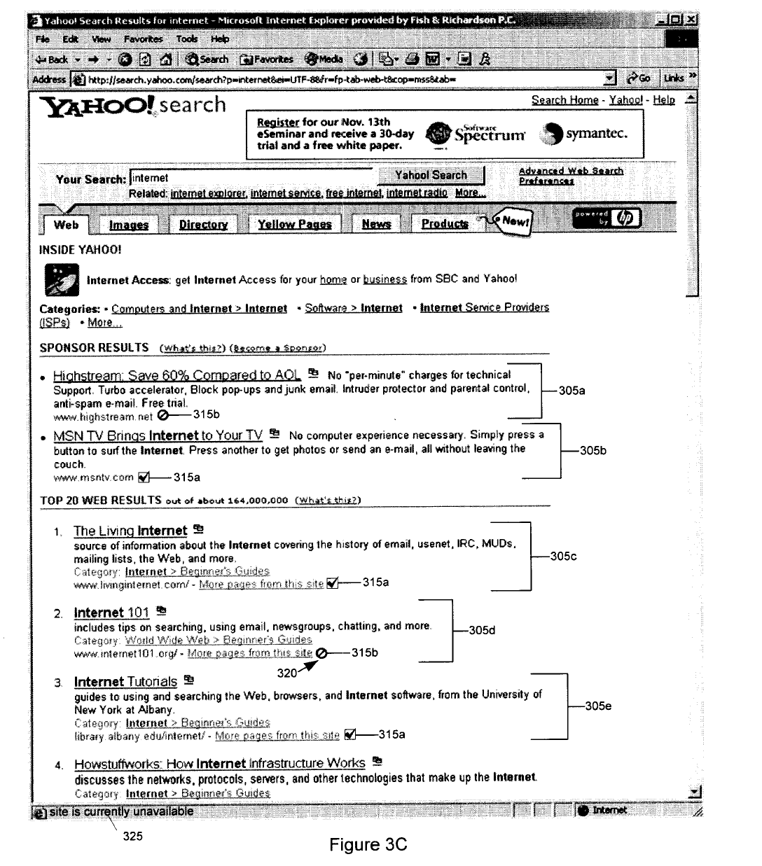

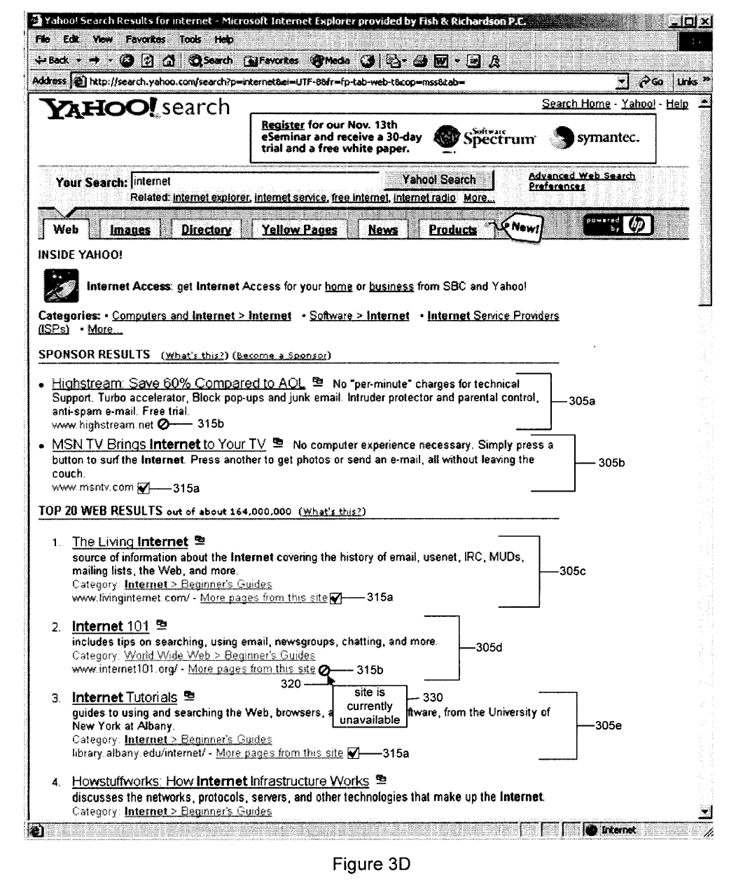

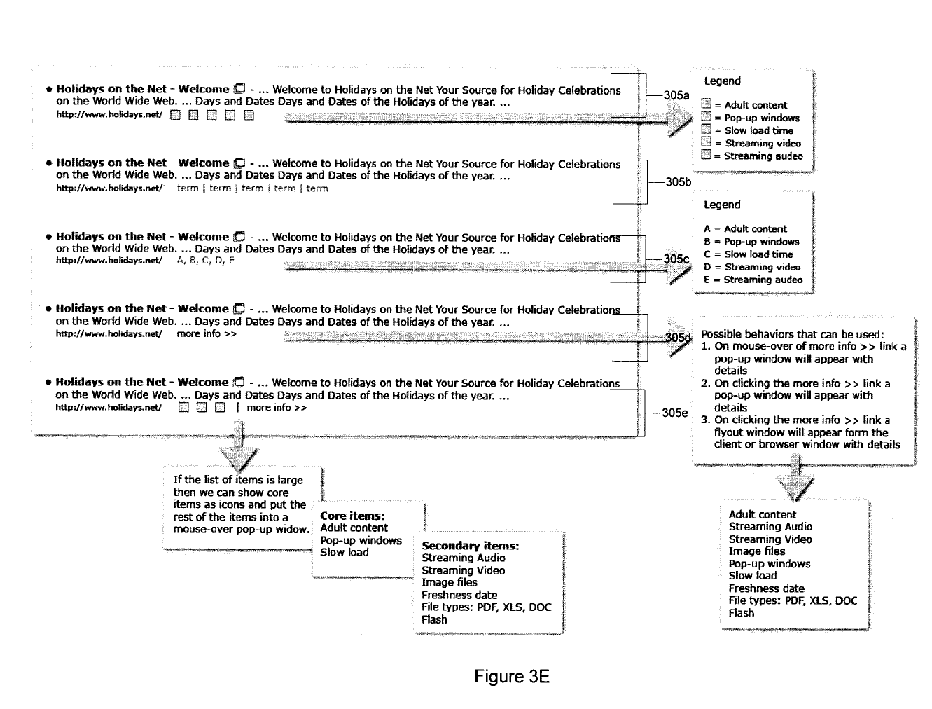

Referring to FIG. 3A, an updated search engine interface 300A provides additional information describing characteristics of content corresponding to search results presented to a user in the search engine interface 300A. Specifically, each of search results 305a-305e is associated with corresponding prose 310a-305e that describes the characteristics of the content corresponding to the search result. For example, the search result 305c includes prose 310c that indicates that content corresponding to the search result 305c is currently unavailable. In one implementation, a cached version of the unavailable content corresponding to the search result 305c may be made available.

The prose 310a-310e may indicate whether the content associated with the corresponding search results 305a-305e is currently available for access by the user. The prose 310a-310e also may indicate whether the content is appropriate for certain ages. For example, prose 310d may inform the user that content associated with a search result 305d corresponding to the prose 310d is inappropriate for minors, or that the content is appropriate for minors.

In addition, the prose 310a-310e may indicate whether displaying the content associated with the search results 305a-310e leads to the display of advertisements. For example, prose 310a may inform the user that content associated with a search result 305a corresponding to the prose 310a spawns a pop-up advertisement, a pop-under advertisements, or rich media advertisements. A pop-up advertisement is an advertisement that appears in a window distinct from a window that includes main content that is viewed and removes window focus from the window that includes the main content. A pop-under advertisement also is an advertisement that appears in a window distinct from a window that includes main content that is viewed, but the window including the pop-under advertisement appears below the window that includes the main content, and window focus remains on the window that includes the main content. A rich media advertisement is an advertisement that appears in a window that includes the main content to be viewed. The rich media advertisement may cover and obscure a part of the main content, which may be viewed after the rich media advertisement is manually dismissed.

The prose 310a-310e may indicate the presence of multimedia content among the content associated with the search results 305a-305e. Multimedia content includes audio content, video content, or kinds of content other than text and images. For example, prose 310b may inform the user that content associated with a search result 305b corresponding to the prose 310b includes or does not include multimedia content.

Furthermore, the prose 310a-310e may indicate a file type included in content associated with a search results 305a-305e corresponding to the prose 310a-310e. For example, the prose 310a-310e corresponding to the search result 305 may inform the user that the content associated with the search results 305a-305e include, for example, a spreadsheet file, a presentation file, or a PDF file.

The prose 310a-310e likewise may indicate a source of the content associated with the search results 305a-305e. For example, prose 310a-310e may inform the user that content associated with the search results 305a-305e corresponding to the prose 310a-310e came from, for example, a message board, a discussion forum, or a web page. The prose 310a-310e also may indicate that people known to the user have viewed content corresponding to the search results 305a-305e. For example, the prose 310e associated with the search result 305e may indicate the member or percentage of people from a list of people known to the user who have viewed the content corresponding to the search result 305. Another metric besides number or percentage of known people may be used to indicate that people known to the user have viewed the content associated with the search results 305a-305e.

The people known to the user may include the user himself. The people known to the user also may include the people listed on a buddy list corresponding to the user; people stored on buddy lists corresponding to people stored in the user's buddy list, and so on, up to a particular number of degrees of separation from the user. The people known to the user also may include all other users belonging to the domain of the user. The people known to the user may actively indicate that the content associated with the search results 305a-305e has been viewed, or an automatic determination may be made as to whether the people known to the user have viewed the content corresponding to the search results 305a-305e.

Referring to FIG. 3B, an alternative search engine interface 300B also may describe characteristics of search results presented to a user in the search engine interface 300B using graphical icons 315a-315c. Specifically, each search result 305a-305e is presented with at least one, and potentially more than one, graphical icon 315a-c315 that indicates characteristics of the content corresponding to the search result 305a-305e. Each icon 315a-315c describes a characteristic of the content corresponding to the search result 305a-305e for which the icon 315a-315c is displayed. For example, the search result 305c includes an icon 315a in the form of a check mark that indicates that content corresponding to the search result 305c is currently available. Similarly, the icon 315b, included in the search result 305a, indicates that content corresponding to the search result for which the icon 315b is displayed is currently unavailable. The search result 305c also includes an icon 315c that informs the user that the content associated with the search result 305c is appropriate for minors. Other icons may be used to illustrate that content is inappropriate for minors, includes advertisements, includes multimedia content, lacks multimedia content, is of a certain file type, is from a particular source, or has been viewed by a certain number of people known to the user.

Referring to FIGS. 3C and 3D, the icons 315a-315c may be selectable to reveal a description of the characteristics of the search results 305a-305e indicated by the icons 315a-315c. The description may include an explanation of the icon 315a-315c as well as a detailed description of the characteristic and how a determination was made that the content for which the icon 315a-315c is displayed has the characteristic represented by the icon 315a-315c. In one implementation, as shown in FIG. 3C, placing the mouse pointer 320 over an icon 315b included in the search result 305d reveals a description 325 of a characteristic of content corresponding to the search result 305d at a location away from the search result 305d. Specifically, the icon 315b indicates that the search result 305d is unavailable, and the description 325, which is located at the bottom left comer of the interface, describes the icon 315b by saying that the content is currently unavailable. In another implementation, a mouse button may be clicked while the mouse pointer 320 is over the icon 315b to reveal the description 325.

In another implementation, as shown in FIG. 3D, placing the mouse pointer 320 over an icon 315b included in a search result 305d reveals a tool tip 330 that includes text describing a characteristic of content corresponding to the search result 305d. Specifically, the icon 315b indicates that the search result 315 is unavailable, and the text included in the tool tip 330 describes the icon 315b by saying that the content is currently unavailable. In another implementation, a mouse button may be clicked while the mouse pointer 315 is over the icon 315b to reveal the tool tip 330. In yet another implementation, the mouse pointer 320 may be held over the icon 315b for a period of time before the tool tip 330 is displayed.

Referring to FIG. 3E, a search engine interface 300C also provides additional information describing characteristics of content corresponding to search results presented to a user in the search engine interface 300C. Each of the search results 305a-305e is presented with an indication of the characteristics of the content corresponding to the search results 305a-305e. The indications may be prose or graphical icons. Interaction may occur with the prose or the graphical icons to display additional information describing the characteristics of the content associated with the corresponding search results 305a-305e.

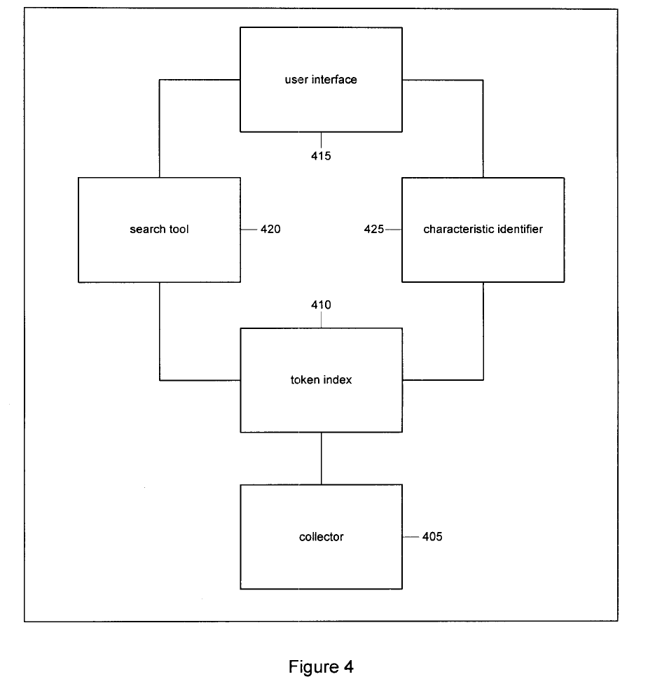

Referring to FIG. 4, a search engine 400 visits web pages to gather information that is helpful in returning search results that match entered search criteria. The search engine 400 also may gather information describing the content of the web pages visited for display when the visited web pages are identified as search results that match the search criteria. The search engine 400 includes a collector 405 that visits and gathers information from web pages in the form of tokens to be stored in a token index 410. The search engine also includes a user interface 415 to the search tool 420 that uses the information stored in the token index 410 to return search results, the characteristics of which are determined by a characteristic identifier 425.

In one implementation, the collector 405 starts at an initial web page and follows links included in the initial web page to access subsequent web pages. The collector 405 then accesses the web pages to which the subsequent web pages are linked to access more web pages, and so on. When a web page is visited, the collector 405 generates text-based tokens to be stored in the token index 410. The tokens are stored in the token index 410 based on the web page for which the token was generated. The tokens may describe the contents of the web page as well as the characteristics of the contents of the web page. For example, tokens may be generated to describe whether the content of the web page is available, the maturity level of the content, or the presence of advertisements within the content. In addition, tokens may be generated to indicate the presence of multimedia content within the content, the presence of a certain type of file within the content, the source of the content, or the people who have visited the web page.

The search engine 400 also includes a user interface 415 which may be used to enter search criteria. The user interface 415 passes the search criteria to a search tool 420, which searches the token index 410 to identify web pages that match the search criteria. The search tool 420 examines the tokens within the token index 410 that describe the contents of the web pages visited by the collector 405 to find the tokens that match the search criteria. The web pages corresponding to the matching tokens are returned by the search tool 420 to the user interface 415 as search results.

After the search results have been identified, the characteristic identifier 425 accesses the tokens from the token database 410 that correspond to the search results and that describe the characteristics of the content corresponding to the search results. The characteristic identifier 425 uses the accessed tokens to identify characteristics of the content associated with the search results. Indications of the identified characteristics are sent to the user interface 415 for display.

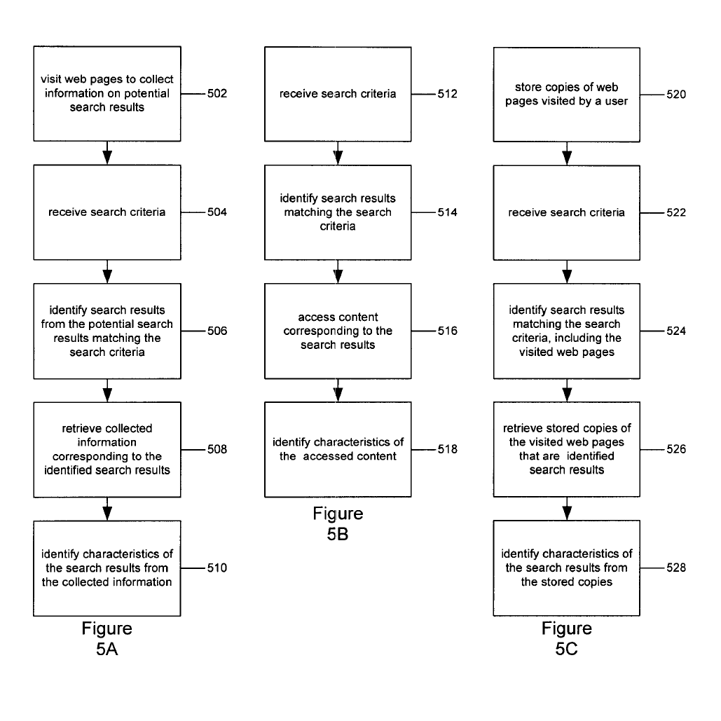

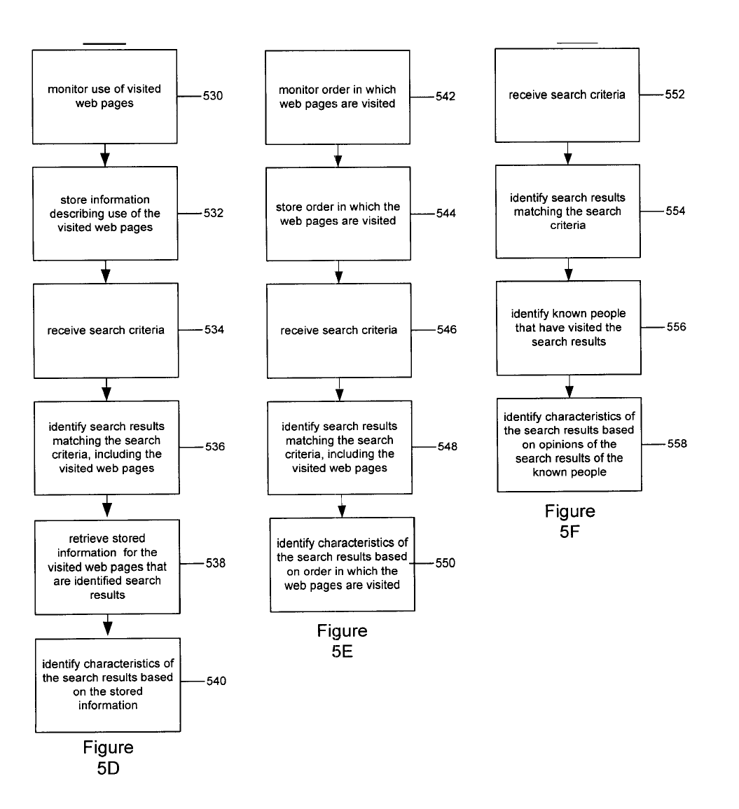

FIGS. 5A-5F are flow charts of characteristic identification processes 500A-500F that may be used to identify characteristics of content corresponding to one or more search results. The characteristics identified as a result of the characteristic identification processes 500A-500F may be displayed for a user of a search engine to better inform the user about the search results.

Referring to FIG. 5A, a characteristic identification process 500A gathers information describing the characteristics of potential search results as part of the preparation for identifying search results that match entered search criteria. The gathered information is used to identify the characteristics of the identified search results. The characteristic identification process 500A includes visiting web pages to collect information on the web pages for use in returning the web pages as search results (502). The collected information for a page describes the content of the page as well as characteristics of the content of the page. After the information has been collected, search criteria are received (504), and the collected information is used to identify search results matching the search criteria (506). The collected information describing the characteristics of content corresponding to the search results is retrieved (508), and that information is used to identify characteristics of content corresponding to the search results that then are displayed (510).

Referring to FIG. 5B, a characteristic identification process 500B identifies characteristics corresponding to search results after the search results have been identified. The characteristic identification process 500B includes receiving search criteria (512), and identifying search results that match the search criteria (514). Content corresponding to the search results is accessed (516). Since the accessed content is the content for which the characteristics are to be identified by the characteristic identification process 500B, characteristics of the accessed content are determined (518). The characteristics may be determined from an external service, such as, for example, a ratings service that determines a maturity level for the accessed content.

Referring to FIG. 5C, a characteristic identification process 500C stores copies of web pages viewed by a user. The stored web pages are used to identify the characteristics of content corresponding to identified search results when content includes at least one of the stored web pages. The characteristic identification process 500C includes storing copies of web pages viewed by the user (520). Search criteria are received (522), and search results matching the search criteria are identified (524). Among the content corresponding to the search results may be one of the web pages of which a copy was stored by the user because the user previously viewed the web page. The stored copies of the visited web pages that are search results are retrieved (526), and the stored copies are used to identify characteristics of the content corresponding to the search results that are then displayed (528).

Referring to FIG. 5D, a characteristic identification process 500D monitors the web activity of a user to store information regarding how the user interacts with each of the pages viewed by the user. The information describing the use of the page may include the time spent viewing the page, the scrolling activity while viewing the page, information copied from the page, and information entered into forms on the page. The information describing how the user uses the pages aids in identifying the characteristics of the content of the pages when the pages are identified as search results. The characteristic identification process 500D includes monitoring a user's use of web pages (530). Information describing the user's use of the web pages is stored (532). Search criteria are received (534), and search results matching the search criteria are identified (536). Among the search results may be one of the web pages for which the user's use of the page was stored. The stored information regarding the user's use of the search results is retrieved (538). After retrieval, the stored information is used to identify characteristics of the search results that were previously viewed by the user (540).

Referring to FIG. 5E, a characteristic identification process 500E monitors the web activity of a user to identify the order in which the user views web pages. The information describing the order in which the user views the pages aids in identifying the characteristics of the content of the pages when the pages are identified as search results. The characteristic identification process 500E includes monitoring the order in which the user views web pages (542) and storing that order (544). Search criteria are received (546), and search results matching the search criteria are identified (548). Among the search results may be one of the web pages already viewed by the user. The stored information regarding the order in which the user views web pages is used to identify characteristics of the search results that were previously viewed by the viewer (550).

Referring to FIG. 5F, a characteristic identification process 500F identifies people known to a user who have viewed content corresponding to identified search results to determine characteristics of the content corresponding to the identified search results. The characteristic identification process 500F includes receiving search criteria (552) and identifying search results that match the search criteria (554). The people known to the user who have viewed the search results are identified (556). In one implementation, the people known to the user may be stored on a list that is manually or automatically maintained. Characteristics of content corresponding to the search results are identified based on opinions of the content of the people known to the user (558). For example, the people known to the user may record that content corresponding to the search results has been viewed. The people also may submit an opinion of the content. The opinions may be collected and examined to determine the characteristics of the content corresponding to the search results.

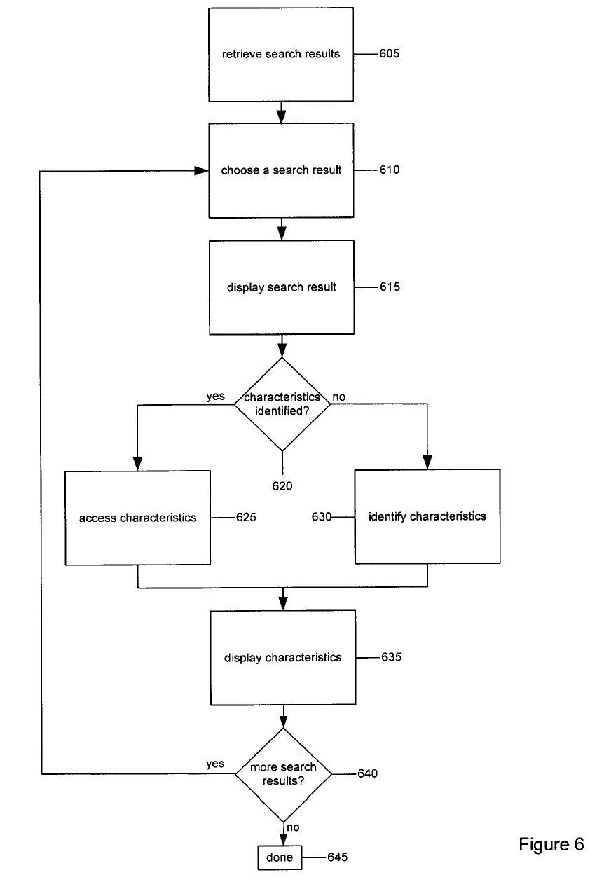

Referring to FIG. 6, a search result display process 600 displays search results along with descriptions of the characteristics of content corresponding to the search results. The display process 600 includes retrieving search results (605). The search results are retrieved to match search criteria that have been entered. One of the search results is chosen (610), and the search result is displayed (615). In one implementation, displaying a search result may include displaying a title of the search result that also enables access to content corresponding to the title, as well as a summary of the content and an indication of the location of the content.

A determination is made as to whether characteristics of the content corresponding to the chosen search result have been identified (620). If the characteristics have been identified, then the characteristics are accessed (625). If the characteristics have not been identified, then the characteristics are identified (630). The accessed or identified characteristics then are displayed (635).

In one implementation, displaying the characteristics includes displaying prose describing the characteristics near the search result, such as in the search engine interface 200A of FIG. 2A. In another implementation, displaying the characteristics comprises displaying one or more graphical icons representing the characteristics near the search results such as in the search engine interface 200B of FIG. 2B. The icons may be selected to reveal text describing the characteristics.

A determination is made as to whether more search results exist to be displayed (640). If so, the process of choosing a search result (610), displaying the search result (615), and displaying characteristics of content corresponding to the search result (635) is repeated. In this way, the search results and characteristics of content corresponding to the search results are sequentially displayed until there are no more search results to be displayed (640), at which point the display process 600 is complete (645).

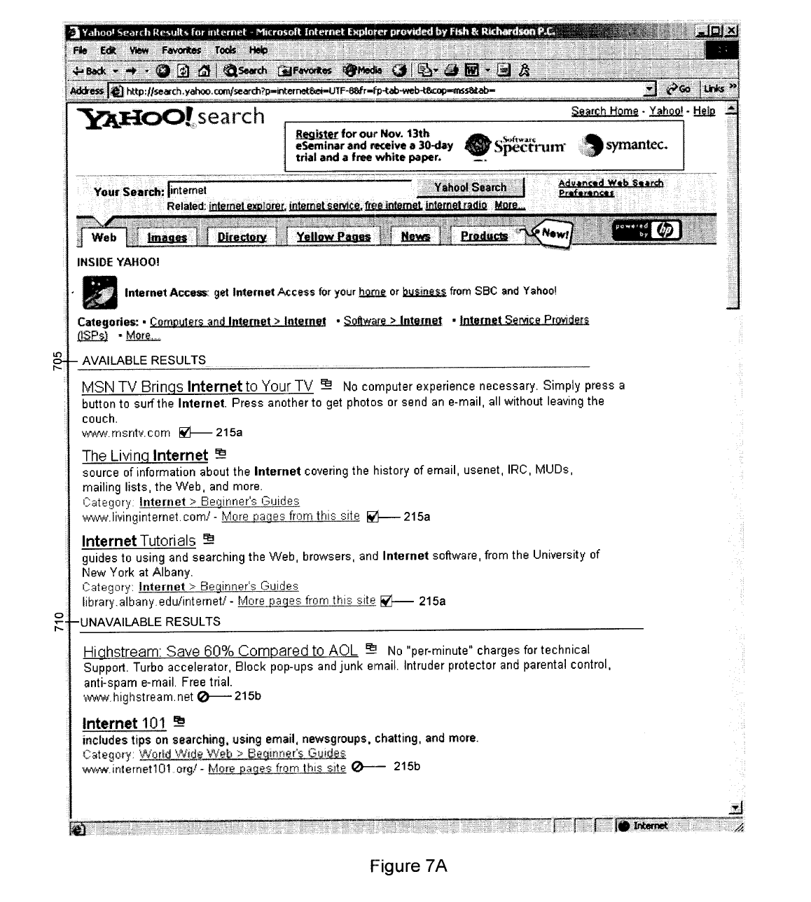

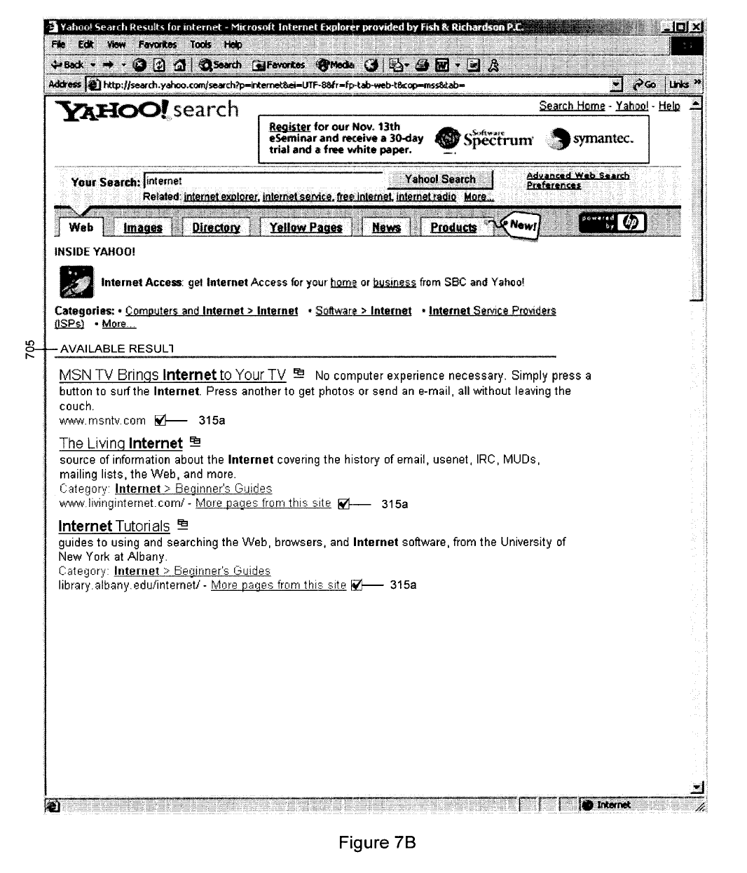

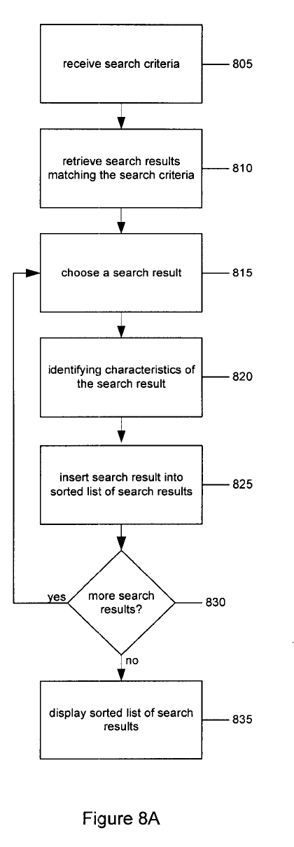

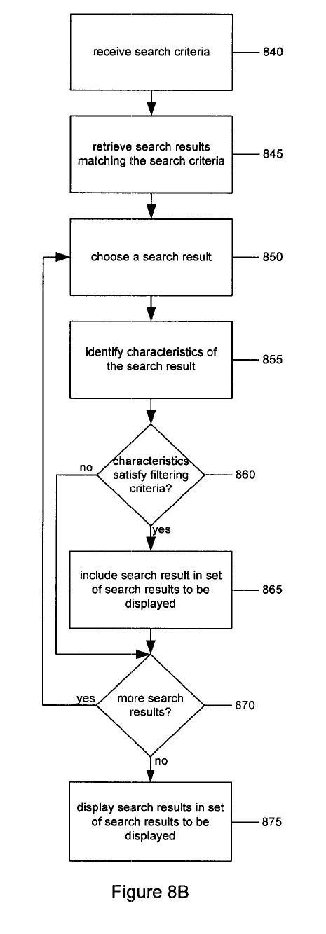

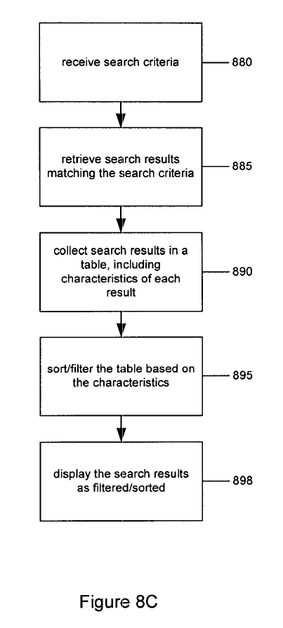

After characteristics corresponding to search results identified as matching entered search criteria have been identified, the search results may be sorted or filtered based on the characteristics. Sorting and filtering the search results enables a user to see only search results in which the user is interested, or to see the results first. Sorting and filtering the search results also enables the user to see later or not at all search results in which the user is not interested. FIGS. 7A and 7B illustrate search engine interfaces in which search results are sorted and filtered, respectively. FIGS. 8A and 8B illustrate processes for sorting and filtering, respectively, search results based on the characteristics, and FIG. 8C illustrates an alternative process for sorting and/or filtering search results.

Referring to FIG. 7A, a search engine interface 700A includes search results that have been sorted based on the availability of content corresponding to the search results. The search engine interface 700A includes a heading 705 under which search results corresponding to content that is available are displayed. Each of the search results under the heading 705 corresponds to content that is available, as evidenced by the icon 215a included in each of the search results that is representative of search results with available content. Similarly, the search engine interface 700.A includes a heading 710 under which search results corresponding to content that is unavailable are displayed. Each of the search results under the heading 710 corresponds to content that is unavailable, as evidenced by the icon 215b included in each of the search results that is representative of search results with unavailable content. Results corresponding to available content are displayed before results corresponding to unavailable content to bring attention first to the search results corresponding to available content.

The search engine interface 700A may sort the search results based on other characteristics of the content corresponding to the search results. Different headings 705 and 710 may be used to separate the search results into groups based on the characteristic used to sort the search results. For example, the search results may be sorted by required maturity level, and search results of one maturity level may be displayed before search results of another maturity level. Likewise, the search results may be sorted by type of advertisements included in the content, and search results including one type of advertisements may be displayed before search results with another type of advertisements. In addition, search results corresponding to content that does not include advertisements may be displayed before search results corresponding to content that does include advertisements.

The search results also may be sorted based on the presence of multimedia content, and search results corresponding to content that includes multimedia content may be displayed before search results corresponding to content that does not include multimedia content, or vice versa. The search results may be sorted based on file type of the content, and search results corresponding to content that includes one file type may be displayed before search results corresponding to content that includes another file type. The search results may be sorted based on a source of the content, and search results corresponding to content from one source may be displayed before search results corresponding to content from another source. The search results also may be sorted based on the number of people known to a user of the search engine interface 700A who have viewed the search results, and search results corresponding to content viewed by a particular number of known people may be displayed before search results corresponding to content viewed by another number of known people.

In one implementation, the search results may be sequentially sorted based on multiple characteristics. For example, the search results may be sorted on availability, presence of advertisements, and maturity level of the content associated with the search results to present search results corresponding to available content that does not include advertisements and that is appropriate for minors before any other search results are displayed.

Referring to FIG. 7B, a search engine interface 700B includes search results that have been filtered based on the availability of content corresponding to the search results. The search engine interface 700B includes a heading 705 under which search results corresponding to content that is available are displayed. Each of the search results under the heading 705 corresponds to content that is available, as evidenced by the icon 215a included in each of the search results that is representative of search results with available content. The search engine interface 700A purposefully omits from display search results corresponding to content that is unavailable. Results corresponding to available content are displayed to bring attention first to the search results corresponding to available content. Results corresponding to unavailable content are purposefully omitted to prevent bringing attention to search results corresponding to content that is unavailable.

The search engine interface 700B may filter the search results based on other characteristics of the content corresponding to the search results. For example, the search results may be filtered by required maturity level. In such a case, only search results of a particular maturity level may be displayed, and other search results may be purposefully omitted from display. Likewise, the search results may be filtered by type of advertisement included in the content, such that only search results with a certain type of advertisements, or without any advertisements, may be displayed, and other search results may be purposefully omitted from display.

The search results also may be filtered based on the presence of multimedia content, file type of the content, or a source of the content, such that only search results with or without multimedia content, corresponding to content that includes a particular file type, or corresponding to content from a particular source, may be displayed, and other search results may be purposefully omitted from display. The search results also may be filtered based on the number of people known to a user of the search engine interface 700A who have viewed the search results, such that only search results corresponding to content viewed by more than a threshold number of known people may be displayed, and other search results may be purposefully omitted from display.

In one implementation, the search results may be sequentially filtered based on multiple characteristics. For example, the search results may be filtered on availability, presence of advertisements, and maturity level of the content associated with the search results to present only search results corresponding to available content that does not include advertisements and that is appropriate for minors, and to purposefully omit other search results.

Referring to FIG. 8A, a sorting process 800A is used to sort search results for display on a search engine interface, such as the search engine interface 700A from FIG. 7A. The sorting process 800A includes receiving search criteria (805). Search results that match the received search criteria are retrieved (810). The retrieved search results are to be sorted before being displayed. One of the search results is chosen (815). Characteristics of content corresponding to the chosen search result are identified (820). For example, the processes 500A-500F may be used to identify the characteristics of the content corresponding to the chosen search result. Based on the identified characteristics and the characteristics over which the search results are being sorted, the chosen search result is inserted into an appropriate location within a sorted list of search results, which is initially empty (825). The location in the sorted list of search results is determined such that the chosen search result is placed with other search results that have the same values for the characteristics over which the search results are sorted. If no other search results have the same value as the chosen search result, then the chosen search result is placed at the end of the sorted list of search results.

A determination is made as to whether there are more search results to be sorted (830). If so, a search result is chosen (815), characteristics of the search result are identified (820), and the search result is inserted into an appropriate location within the sorted list of search results (825). In this way, each of the search results is inserted into the sorted list of search results until there are no more search results to be sorted. When there are no more search results to be sorted (830), the sorted list of search results is displayed (835).

Referring to FIG. 8B, a filtering process 800B is used to filter search results for display on a search engine interface, such as the search engine interface 600B from FIG. 6B. The filtering process 800B includes receiving search criteria (840). Search results that match the received search criteria are retrieved (845). The retrieved search results are to be filtered before being displayed. One of the search results is chosen (850). Characteristics of content corresponding to the chosen search result are identified (855). For example, the processes 500A-500F may be used to identify the characteristics of the content corresponding to the chosen search result. Based on the identified characteristics and the characteristic being used to filter the search results, a determination is made as to whether the chosen search result satisfies filtering criteria (860). The filtering criteria define the values of the characteristics that are necessary for the search result to be displayed. If the chosen search result satisfies the filtering criteria, then the chosen search result is included in a set of search results to be displayed (865). If the chosen search result does not satisfy the filtering criteria, then the chosen search result is not placed in the set of search results to be displayed.

A determination is made as to whether there are more search results to be filtered (870). If so, a search result is chosen (850), characteristics of the search result are identified (855), and the search result is included in the set of search results to be displayed (865) if the search result satisfies the filtering criteria (860). In this way, each of the search results is included in the filtered set of search results, if the content corresponding to the search result satisfies the filtering criteria, until there are no more search results to be filtered. When there are no more search results to be filtered (870), the filtered list of search results is displayed (875).

Referring to FIG. 8C, an alternative sorting and filtering process 800C may be used to sort and/or filter search results for display on a search engine interface. The sorting process 800C includes receiving search criteria (880). Search results that match the received search criteria are retrieved (885). The retrieved search results are to be sorted and/or filtered before being displayed. The search results are collected in a table along with characteristics of content associated with the search results (890). The table is sorted and filtered based on the characteristics being used to sort and filter the search the results (895). The contents of the table, which are the search results, are then displayed as sorted and filtered (898).

User Feedback Provided With Search Results

Presenting search results returned by a search engine to a user who has submitted a search query with a description of characteristics of content corresponding to the search results helps the user to better find the information sought by the user. Providing user feedback related to the search results may further aid the user in accessing only the most useful and desirable search results.

In addition, providing user feedback from people who are known to the user may allow the user to glean even more information about the search result based on the user's pre-existing relationship with the user who has provided the feedback. The user who enters the search query to request search results may be referred to as a “searching user” and a user who provides user feedback related to a particular search result to a search query may be referred to as a “feedback-providing users.”

A useful type of feedback (either provided by a feedback-providing user who is known to the searching user or by a stranger) may be feedback related to how relevant the search result is to the search query. Referenced hereinafter as relevancy feedback, this type of feedback may be particularly useful because relevancy feedback may help the user determine if a particular search result can provide meaningful information in response to the user's search query, not just whether the particular search result includes good or bad content in a vacuum. For example, in response to a search query for “Gilmore Girls,” a user may receive a search result of the TV Guide website. Providing feedback for the search result with an indication that the TV Guide website is “a great website for TV addicts” may not be as useful as feedback indicating that the TV Guide website has “a superb Gilmore Girls page.”

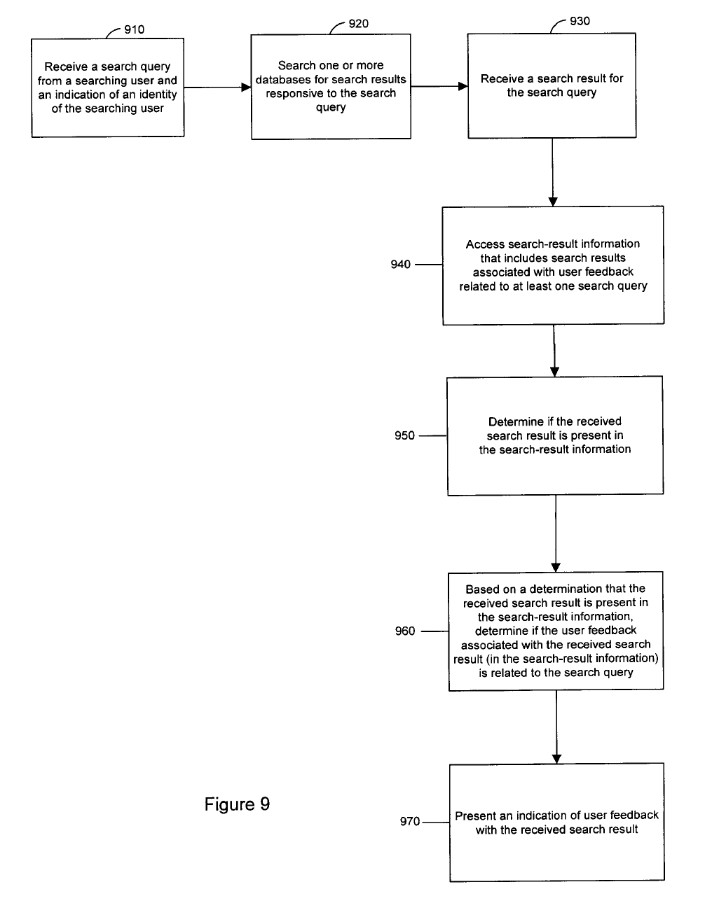

FIG. 9 is a flow chart of a process 900 for providing user feedback with search results received in response to a user-entered search query. Process 900 may be performed by a search system, such as search system 220 of FIG. 2.

The search system 220 may receive a search query from a searching user, as well as an indication of the identity of the searching user (910). The user may enter the search query into a search engine interface, such as one of search engine interfaces 300A and300B of FIGS. 3A and 3B. For example, a user may enter the search query “Gilmore Girls.”

The search system 220 may search one or more databases for search results responsive to the search query (920). The databases searched may typically include websites on the World Wide Web. However, the databases also may include topical subscription services, weblogs (or “blogs”), news services, Really Simple Syndication (“RSS”) feeds, or other electronic content sources. For example, search system 220 may search for any websites mentioning the phrase “Gilmore Girls,” and also may specifically search television or entertainment content sources, such as the TV Guide website or E! Online website, if the system determines that the search query relates to a television or entertainment category. Typically, a search system may determine that a website includes content responsive to a search query by examining metadata, or other tags, associated with the website for words that are the same or similar to the words of the search query. However, other methods of determining search results are within the scope of this description.

Based on searching the databases, the search system 220 may receive search results for the search query (930). For example, in response to searching the databases for the search query “Gilmore Girls,” the search system may receive The WB website as a search result because Gilmore Girls is shown on The WB television network.

The number of search results received may depend on user settings, where a user may specify a number of search results the user wishes to receive on a total or per-page basis or a type of search result to receive, such as search results that indicate child-friendly websites. The number of search results received also may depend on the number of websites or content sources that exist and have content related to the search query. In some cases, only one search result may be returned.

The search system 220 may access search-result information that includes search results that are associated with user feedback related to at least one search query, such as user feedback-search result data store 226 of FIG. 2 (940). In some implementations, search results may be present in the search-result information only if the search result has been associated with user feedback. Alternatively, search results may be present in the search-result information even if no user feedback has been associated with the search result.

The user feedback related to the search results in the search-result information may include several instances of particular user feedback. An instance of user feedback relates to feedback for a search result provided by a single feedback-providing user in response to how relevant the search result is to the search query entered by the feedback-providing user such that the search result was provided to the feedback-providing user. Each instance of user feedback may be associated with a search query (e.g., the search query for which the search result was received at the time the user feedback was provided).

The user feedback is associated with a search query in order for search system 220 to determine whether it makes sense to provide the user feedback based on the search query submitted by the searching user. For example, if a searching user submits the search query “Gilmore Girls,” the search system 220 may provide an instance of user feedback for a search result for The WB website that is associated with a “Gilmore Girls” search query, but not when the instance of user feedback is associated with a search query related to another WB television show, such as “Everwood.” Thus, search system 220 may indicate that the search result has “great interviews with Gilmore Girls cast,” but not that “the link to Everwood cast blog doesn't work.”

In implementations where user feedback for a search result is related to the general quality or content of the search result (rather than the relevancy of the search result to the search query), the user feedback need not be associated with a search query within search-result information.

The content of the user feedback may be stored in the search-result information. Alternatively or additionally, the user feedback may be stored separately from the search results and may be retrieved, when necessary, based on the association between the user feedback and a particular search result. In some implementations, search-result information may include a cached version of a search result stored in the search-result information, such that the cached version may be provided to a user in lieu of the actual search result when the search result is unavailable.

The search system 220 may determine if the received search result is present in the accessed search-result information (950). More particularly, the search system 220 determines if there is a match between the search results (e.g., websites) listed in the search-result information and the search result received in response to the search query submitted by the searching user and received after searching the databases. For example, the received search result may be The WB website and search system 220 may determine if The WB website is included in the search-result information.

Based on determining that the received search result is present in the search-result information, the search system 220 determines if an instance of user feedback associated with the received search result is related to the search query submitted by the searching user (960). In configurations where search results may be stored in the search-result information even if no user feedback has been associated with the search result, search system 220 may determine if the received search result has been associated with one or more instances of user feedback.

As described above, an instance of user feedback may be associated with a search query. Search system 220 may compare the search query submitted by the searching user with the search query associated with the instance of user feedback to determine if the user feedback is related to the search query submitted by the searching user. The user feedback may be related to the search query submitted by the searching user if the search query associated with the user feedback is the same as, or related to, the search query submitted by the searching user.

Two search queries may be related if the search queries have one or more words in common (e.g., “Gilmore Girls” and “Rory Gilmore,” a character on the show), are related to the same topic (e.g., “tourism” and “vacation”) or have the same meaning (e.g., the search queries “VW” and “Volkswagen” both mean the German car manufacturer). For example, a searching user may submit the search query “Gilmore Girls” and receive a search result for The WB website, which is included in the search-result information because at least one instance of user feedback has been associated with The WB website. The instances of user feedback for the search result may be related to search queries for “Rory Gilmore,” “Lorelai” or “Luke,” (characters on the show), “Stars Hollow” (the fictional town where the show takes place), “Tuesdays 8:00 PM” (the day and time that the show airs), “Everwood” or “One Tree Hill” (other television shows on the WB network), or even “Michigan J. Frog” (the network's dancing frog mascot). Search system 220 may compare the search query submitted by the searching user (here, “Gilmore Girls”) with the search queries associated with the multiple instances of user feedback to determine if any of the instances of user feedback are the same as, or related to (e.g., have one word in common (“Gilmore Girls” and “Rory Gilmore”) or relate to the same topic (e.g., “Gilmore Girls” and “Stars Hollow”).

In some implementations, to determine if two search results are related, search system 220 may maintain a database of related search queries. The database may include a seed listing of related search queries and may add to the list as search queries are received, searched, and presented to users. In some implementations, search system 220 may determine if a relationship between two search queries exists on-the-fly based on, for example, words in common or commonality of search results received when the search queries are submitted.

If the user feedback is related to the search query submitted by the searching user, search system 220 presents an indication of the user feedback with the received search result (970). The indication of the user feedback presented may be an indication of an instance of user feedback associated with the search result and related to the search query submitted by the searching user. In some implementations, the indication of user feedback may include an indication that user feedback is available for the search result and may direct a user to take some further action to view the user feedback. In some implementations, the indication of user feedback may include the content of the user feedback.

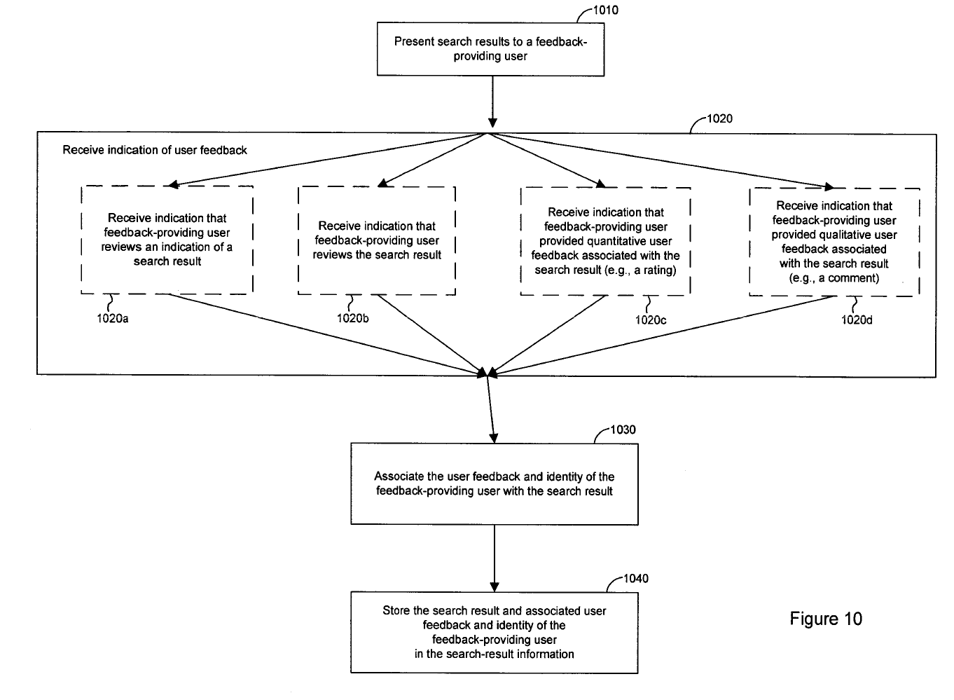

FIG. 10 is a flow chart of a process 1000 for receiving user feedback for a search result and storing the user feedback in search-result information. Process 1000 may be performed by a search system, such as search system 220 of FIG. 2.

Search results may be presented to a feedback-providing user in response to a search query (1010). For example, at some time previous to the searching user requesting, and receiving, search results for the search query “Gilmore Girls,” a feedback-providing user may have been presented with one or more of the received search results. In some implementations, the feedback-providing user need not be presented with the one or more search results in response to entering the exact same search query. For example, the feedback-providing user may be presented with The WB website in response to a search query for “Smallville,” another television show shown on the WB television network.

The search system 220 may receive an indication of user feedback (1020). The indication of user feedback may include various types of user feedback. As one type of user feedback, the search system 220 may receive an indication that the feedback-providing user reviewed an indication of a search result (1020a). For example, the feedback-providing user may have been presented The WB website as a search result and thus had viewed the indication (e.g., link) of the website.

As another type of user feedback, the search system 220 may receive an indication that the feedback-providing user reviewed the search result (1020b). For example, the feedback-providing user may have clicked on the indication (e.g., link) for The WB website upon being presented with it as a search result in order to visit The WB website.

As yet another type of user feedback, the search system 220 may receive an indication that the feedback-providing user has provided quantitative user feedback associated with the search result (1020c). For example, the feedback-providing user may have indicated a ranking for the search result related to the quality, relevance or other metric related to the search result. When a relevance ranking is provided as user feedback, the user feedback may be provided with the search result when the search result is presented to a user in response to the same search query.

Quantitative user feedback also may include a percentage, or number, of users who have viewed the search result indication or the actual search result. This type of quantitative user feedback may be received, and updated, by the search system 220 any time the search result is presented to a user regardless of whether the user provides any substantive user feedback.

As another type of user feedback, the search system 220 may receive an indication that the feedback-providing user has provided qualitative user feedback associated with the search result (1 020d). Qualitative user feedback may include comments provided by the feedback-providing user and may relate to any information the feedback-providing user deems relevant for other users to determine if the search result may be useful, and particularly if the search result is relevant, or responsive, to the search query submitted by the feedback-providing user. The comments may be provided by selecting a comment from a pre-determined list or by entering a comment of the feedback-providing user's own creation.

The user feedback may be associated with the search result and the search query submitted by the feedback-providing user and to which the search result is responsive (1030). For example, a feedback-providing user may indicate a rank of 8 out of 10 for relevancy of The WB website search result to the search query “Smallville.” The rank, as well as the identity of the feedback-providing user who provided the ranking and the search result “Smallville,” may be associated with the search result. The search result, and associated user feedback, identity of the feedback-providing user and search query submitted by the feedback-providing user may be stored in search-result information (1040). For example, the search result and associated user feedback information may be stored together in a single database, or stored separately, but associated in such a way that retrieval of the search, and related search query.

The user feedback information may be aggregated before, or after, being associated with a search result and stored. For example, ranking information related to, for example, relevance of a search result to a search query, may be averaged or otherwise aggregated before being associated and stored with the search result and related search query. In some implementations, rankings may not be aggregated prior to being associated and stored with the search result and related search query in order for the ranking provided by a particular feedback-providing user to be presented to a searching user to whom the feedback-providing user is related. In some implementations, if rankings are associated with search results by multiple feedback-providing users who are related to a particular searching user, the rankings may be aggregated prior to providing the user feedback for a search result to the particular user. In this configuration, the identities of the feedback-providing users who provided the rankings may or may not be provided to the particular searching user.

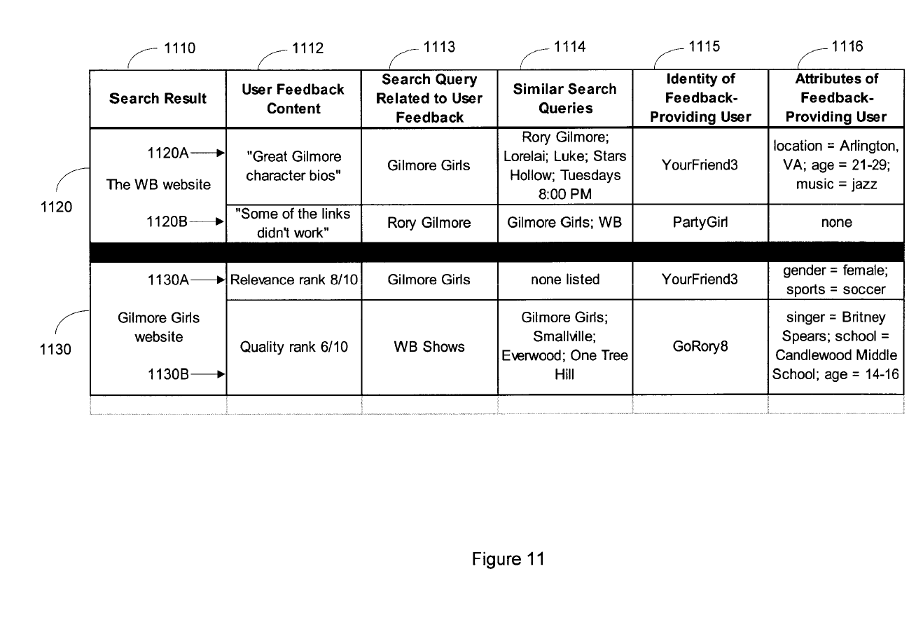

FIG. 11 is an exemplary database for storing search-result information 1100. As described above with respect to FIGS. 9 and 10, search-result information may be used to access user feedback for a search result, determine if the user feedback is related to a search query submitted by a searching user, determine a type of user feedback, determine an identity of a feedback-providing user who provided the user feedback and even retrieve attributes related to a feedback-providing user.

Search-result information 1100 includes columns 1110-1116. More particularly, an indication of a search result, in the form of, for example, a website name or universal resource locator (URL), may be listed in column 1110. Content of user feedback for the search result may be listed in column 1112. In some implementations, rather than the user feedback content being stored in column 1112, the column 1112 may include a pointer to a section of computer readable storage where the content may be stored. Column 1113 may include a search query related to the user feedback and column 1114 may include search queries that are similar to the search query related to the user feedback. As described above, the search query related to the user feedback is the search query submitted by the feedback-providing user prior to the feedback-providing user being provided with the search result and furnishing the user feedback for the search result. The information in column 1114 as to related search queries may be based on a related search query database or logic within search system 220. In some implementations, rather than including the related search queries directly within column 1114, column 1114 may include a pointer to the related search queries as stored elsewhere.

The identity of the feedback-providing user who provided the user feedback may be stored in column 1115 and any attributes known to be associated with the feedback-providing user may be stored in column 1116. Again, a pointer to another area of computer readable storage where attribute information is stored may be listed in column 1116 rather than a full list of the attributes.

Search-result information 1100 also includes rows 1120 and 1130. The rows include information for each of columns 1110-1116 for a particular search result. If more than one instance of user feedback is stored within search-result information 1100 for a single search result, the row for the search result may be split into an appropriate number of rows to include information for each instance of user feedback for a single search result. For example and as shown, the search result The WB website is associated with two instances of user feedback. Thus, row 1120 is split into one row for each instance of user feedback, e.g., rows 1120A and 1120B. The same is true for row 1130 for the Gilmore Girls website search result.

In one example, a search result The WB website is located within column 1110. The first instance of user feedback for this search result “Great Gilmore character bios” is included in column 1112 of row 1120A. In the same row, the search query “Gilmore Girls” that is related to the instance of user feedback is located in column 1113 and search queries that are similar to the search query listed in column 1113, such as, for example, “Rory Gilmore,” are located in column 1114. The identity of the feedback-providing user, e.g., YourFriend3, is located in column 1115 and the attributes associated with the identity of the feedback-providing user, such as, for example, a location of Arlington, Va., are located in column 1116.

Other information related to user feedback for a search result also may be included in search-result information 1100 although not shown in FIG. 11. For example, search-result information 1100 may be configured to include an indication of users known to a feedback-providing user, a list of other search results for which a particular feedback-providing user has provided user feedback, relationships between search results and an indication of users who have viewed a search result but who have not provided user feedback.

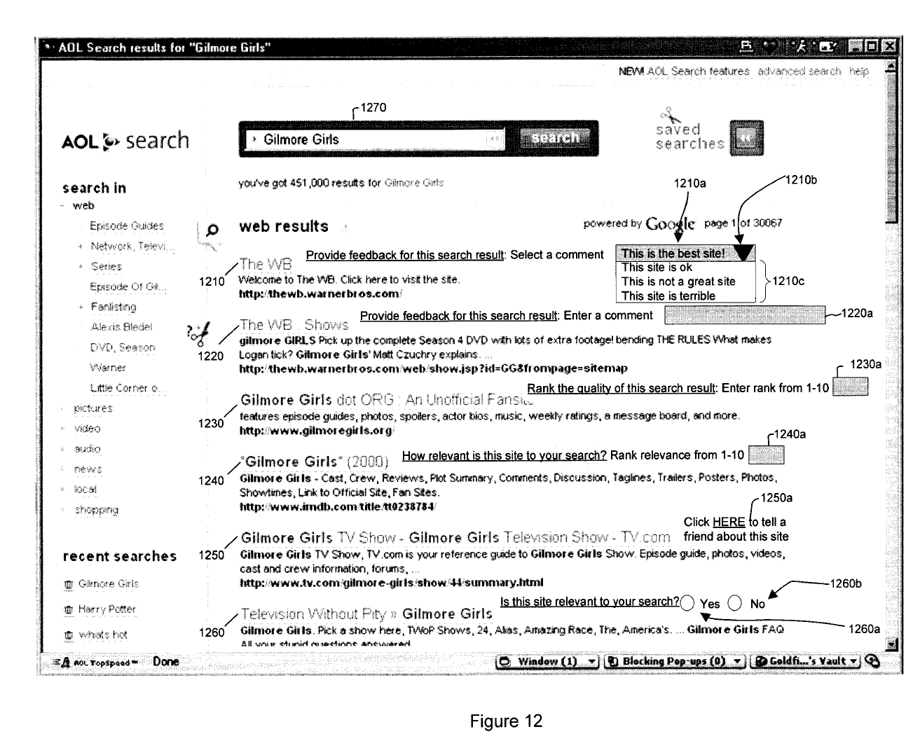

FIG. 12 is a graphical user interface (GUI) 1200 for providing user feedback for a search result related to a search query. Graphical user interface 1200 includes search results 1210-1260 that have been received in response to the search query “Gilmore Girls,” as shown in search query text entry box 1270. Graphical user interface 1200 also includes exemplary elements 1210a-1210c, 1220a, 1230a, 1240a, 1250a and 1260a-1260b for providing user feedback for one or more of search results 1210-1260.

A feedback-providing user may provide a comment related to search result 1210, The WB website, by selecting among pre-determined comments that are set forth by graphical user interface 1200. For example, a feedback-providing user may select a comment to be provided in comment entry box 1210a. The feedback-providing user may click on down arrow 1210b to reveal drop-down menu 1210c and select from pre-determined user feedback comments. As shown, the comment “This is the best site!” has been selected by the feedback-providing user and placed in comment entry box 1210a.

User feedback may be provided for search result 1220, The WB Shows, by entering a comment of the feedback-providing user's own invention into comment entry box 1220a. In some implementations, a feedback-providing user may be limited by a number of characters or type of language that may be included as a user feedback comment. Furthermore, in some implementations, a feedback-providing user's comments may include a hyperlink, a graphic, or a sound.

A feedback-providing user may provide user feedback in the form of a quality rank for search result 1230, Gilmore Girls Unofficial Fansite. The feedback-providing user may enter a value from 1-10 in rank entry box 1230a to indicate the quality of the search result.

Similarly, a feedback-providing user may provide a relevance rank of 1-10 in rank entry box 1240a to indicate how relevant search result 1240, Gilmore Girls website, is to the search query “Gilmore Girls.”

In some implementations, user feedback may not be provided directly through graphical user interface 1200. In this configuration, a feedback-providing user may be provided with a hyperlink that the feedback-providing user may click to enter user feedback for a particular search result, such as search result 1250, Gilmore Girls TV Show. Hyperlink 1250a may cause another website to be presented to the feedback-providing user for entering user feedback or may cause an e-mail message to open in order for the feedback-providing user to provide user feedback about search result 1250 via e-mail.

A feedback-providing user also may provide user feedback by selecting a yes or no indication for whether the search result 1260, Television Without Pity: Gilmore Girls, is relevant to the search query “Gilmore Girls.” The feedback-providing user may indicate that the search result is relevant by selecting radio button 1260a and may indicate that the search result is not relevant by selecting radio button 1260b.

Other methods for providing user feedback are also within the scope of this description.

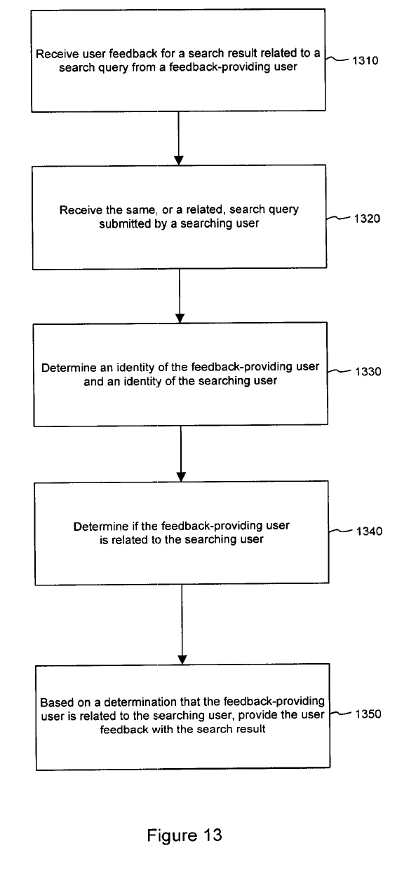

FIG. 13 is a flow chart of a process 1300 for presenting user feedback for a search result related to a search query based on whether the user feedback was provided by a person related to a searching user. Process 1300 may be performed by a search system, such as search system 220 of FIG. 2

The search system 220 may receive user feedback for a search result related to a search query from a feedback-providing user (1310). The search result and related user feedback information (including identity of the user who provided the user feedback and a search query related to the user feedback) may be received by the search system upon accessing search-result information, as described with respect to FIG. 9. For example, search system 220 may receive user feedback indicating that the search result Gilmore Girls website is the “Best GG site” related to the search query “Gilmore Girls.”

The search system 220 may receive the same, or a related search query from a searching user (1320). At some point after receiving the user feedback, a searching user may enter a search query. The search query may be the same as the search query submitted by the feedback-providing user and in response to which the search result was received and the user feedback provided. For example, the searching user may enter the search query “Gilmore Girls.” The search query also may be a search query that is not the same as, but is related to, the search query previously submitted by the feedback-providing user, such as, for example, “Rory Gilmore.”

The search system may determine an identity of the feedback-providing user and an identity of the searching user (1320).The identity of the feedback-providing user may be received upon accessing search-result information, as described with respect to FIG. 10. For example, the search system 220 may determine that the feedback-providing user who provided the user feedback for the Gilmore Girls website has a screen name of GGFan79. The identity of the searching user may be received at the time the searching user submits the search query or upon providing the searching user with search results that are responsive to the search query. For example, the search system 220 may determine that the searching user has a screen name of Inquisitor33.

The search system may determine if the feedback-providing user is related to the searching user (1340). A feedback-providing user may be deemed related to the searching user if the feedback-providing user is known to the searching user or has attributes in common with, or similar to, those of the searching user.

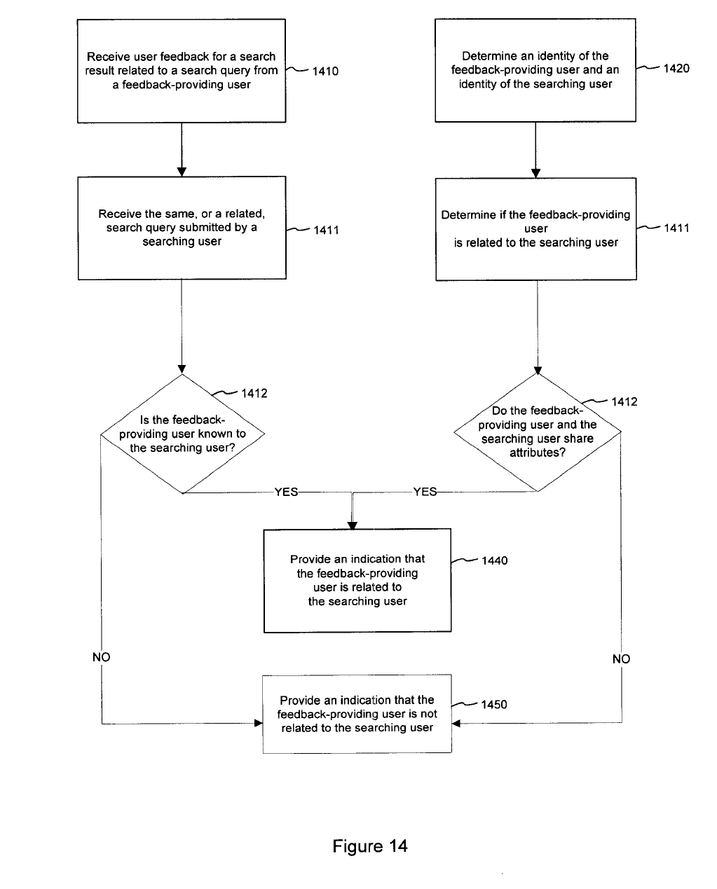

FIG. 14 is a flow chart of a process 1400 for determining if a feedback-providing user is related to a searching user. More particularly, process 1400 is a specific implementation of operation 1340 of FIG. 13. Process 1400 also may be performed by search system 220 of FIG. 2.

Search system 220 accesses a list of people who are known to the searching user (1410). The known people list may be accessed by the search system 220 from the known people list data store 224 of FIG. 2. For example, the searching user who submitted the search query “Gilmore Girls” may have a known people list associated with the searching user. The known people list may be generated and stored based on explicit and implicit actions by the searching user, as described in more detail below.

The search system 220 may compare the identity of the feedback-providing user with the identities in the known people list (1411). For example, the search system 220 compares the identity GGFan79 with the identities listed in the known people list for the searching user.

The search system 220 determines if the feedback-providing user is known to the searching user based on whether the identity of the feedback-providing user is an identity included in the list of known people (1412).

The search system 220 also accesses attributes related to the searching user and the feedback-providing user (1420). In some implementations, the attributes may be stored in a database of user profiles and the search system 220 may seek the attributes of the searching user and the feedback-providing user by supplying an identifier related to each of the two users to the database. Alternatively, the search system 220 may receive the attributes from local storage or some other location of computer storage medium. Attributes may include, for example, demographic information (e g., age, income, profession, education level), geographic location, interests (e.g., movies, particular sports teams, music genres), frequently visited websites, past search queries, etc. For example, search system 220 may determine that the searching user has attributes related to New York Giants, chocolate, and jazz, while the feedback-providing user has attributes related to Arlington, Va., 21-29 years old, and jazz.

Search system 220 may compare the attributes of the searching and feedback-providing users (1421). The comparison may be to determine if the two users have any of the same attributes or any related attributes. In some implementations, search system 220 may have access to a database (not shown) that indicates attributes that are related to one another. For example, the database may indicate that the attribute Washington Redskins is related to the geographic location of Washington, D.C.

The search system may determine if the searching user and the feedback-providing user have attributes in common based on the comparison (1422).

Operations 1410-1412 may be performed in parallel with operations 1420-1422 (as shown) or may be performed in a serial manner either before or after operations 1420-1422.

If the identity of the feedback-providing user is an identity included in the list of known people or the searching user and feedback-providing user share attributes, the search system 220 may provide an indication that the feedback-providing user is related to the searching user (1430). Only one of these conditions is necessary to determine that the feedback-providing user is related to the searching user, but the same result would exist if both were true (e.g., the feedback-providing user is known to the searching user and the feedback-providing user and the searching user share attributes). If neither of these situations exists, the search system 220 may provide an indication that the feedback-providing user is not related to the searching user (1440).

Referring again to FIG. 13, based on a determination that the feedback-providing user is related to the searching user, search system 220 provides the user feedback with the search result (1350). For example, the user feedback provided by feedback-providing user GGFan79 “Best GG site” may be provided to the searching user along with the search result Gilmore Girls website, if the identity GGFan79 is an identity listed in the known people list.

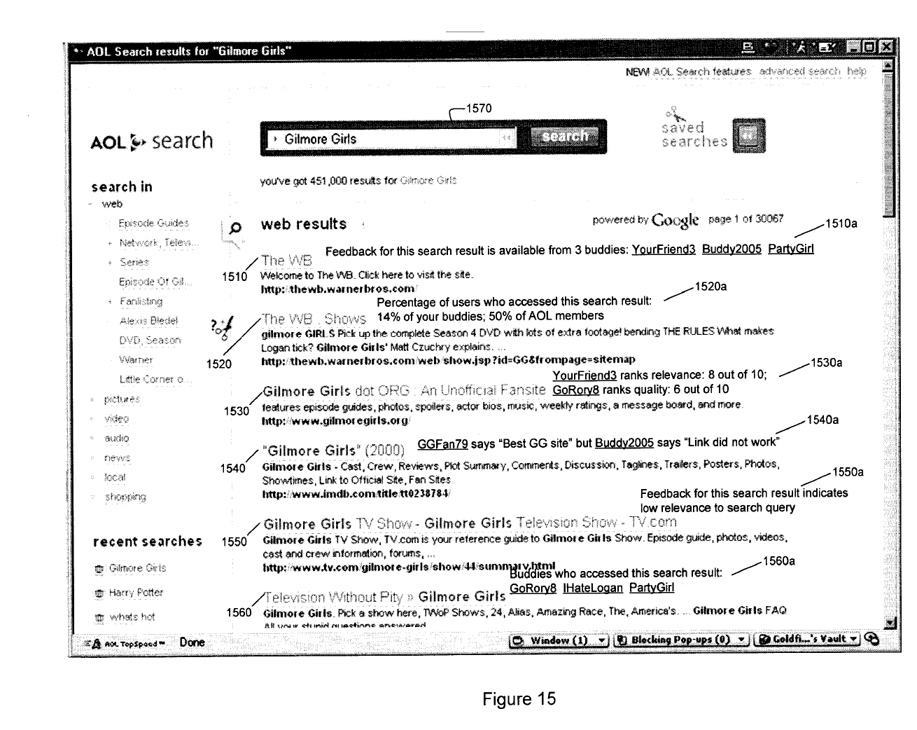

FIG. 15 is a graphical user interface (GUI) 1500 depicting search results provided with user feedback. Graphical user interface 1500 includes search results 1510-1560, as well as user feedback 1510a, 1520a, 1530a, 1540a, 1550a and 1560a for each of search results 1510-1560. Graphical user interface 1500 also includes search query text entry box 1570 showing “Gilmore Girls” as the search query to which the search results 1510-1560 are responsive.

Search result 1510, The WB website, includes user feedback 1510a indicating that user feedback has been provided for search result 1510 by 3 people who are known to the searching user (e.g., buddies) and having screen names YourFriend3, Buddy2005 and PartyGirl. To view the user feedback provided by one of the buddies, the searching user may click on the buddy's screen name. By knowing the identity of the feedback-providing user, the searching user may determine if the user feedback is worth reviewing. For example, if YourFriend3 is a big Gilmore Girls fan, the searching user may be more likely to read the user feedback provided by YourFriend3, than perhaps the user feedback provided by PartyGirl, who the searching user knows has bad taste in television shows. The user feedback that may be provided to the searching user upon clicking on the screen name of a feedback-providing user may be qualitative and/or quantitative user feedback.

Quantitative user feedback 1520a, in the form of a percentage of users who have accessed the search result (e.g., clicked on the hyperlink and visited the website referred to by the search result) may be provided for search result 1520, The WB Shows website. User feedback 1520a indicates that 14% of people known to the searching user (e.g., buddies) have accessed the search result 1520 and 50% of America Online (or AOL) members have done the same. User feedback, such as user feedback 1520a also may indicate a percentage of the general public who have accessed search result 1520, although that is not shown here. Furthermore, quantitative user feedback of this type may additionally or alternatively include a total number of people, rather than a percentage of people, who have accessed the search result.

Search result 1530, Gilmore Girls Unofficial Fansite, is provided with user feedback 1530a. User feedback 1530a indicates a quality rank of 8 out of 10 provided by YourFriend3 and a quality rank of 6 out of 10 provided by GoRory8, both of whom are known to the searching user.

User feedback 1540a, which is provided with search result 1540, Gilmore Girls website, is an example of an aggregation of user feedback provided by more than one feedback-providing user. User feedback 1540a indicates that GGFan79 commented that search result 1540 is the “Best GG site,” while Buddy2005 commented that the link for search result 1540 “did not work.” This type of aggregation of negative and positive user feedback may aid the searching user in instantly recognizing whether people known to the searching user had a positive or negative reaction to the search result. Additionally, or alternatively, more than one positive comment, or more than one negative comment, may have the same effect on the searching user. The comments indicated in user feedback 1540a may have been provided by the feedback-providing users by selecting among pre-determined comments or entering a comment of the feedback-providing user's own invention.

User feedback 1550a indicates that feedback for search result 1550, Gilmore Girls TV Show website, indicates a low relevance to the “Gilmore Girls” search query. User feedback 1550a is another example of an aggregation of user feedback, such as a yes/no indication of relevancy, content of a selected, or created, comment, or a relevancy rank provided by multiple feedback-providing users. User feedback 1550a may have been aggregated and created from user feedback provided by feedback-providing users who are known or not known to the searching user.

Search result 1560, Television Without Pity: Gilmore Girls, includes a list of known people (e.g., buddies) who have accessed the search result. User feedback 1560a indicates that GoRory8, IHateLogan and PartyGirl have accessed the Television Without Pity: Gilmore Girls website by clicking on the hyperlink indication of search result 1560. A user may click on the screen name of one of the feedback-providing users to send an e-mail message or initiate an instant messaging, or chat, communications session with the feedback-providing user.

Identifying People Known to a User

The people a user is presumed to know or be associated with may be determined using a number of techniques. The user may specify the people known to him manually, for example, by making manual changes to an address book, buddy list, or white list. Alternatively, or additionally, the people known to a user may be inferred by monitoring the actions of the user. For example, people to whom the user sends e-mail may be considered as known to the user. Likewise, saving a message from a person may signal that the user knows that person.

This information about people that the user knows is used to determine when, and what, user feedback for search results to provide to the user.

The term “people” is used throughout to refer to the entities with which communication occurs. However, communication can occur with entities that are not individual human beings. Communications can occur with a company, an organization, or a system that is not itself a human being. For example, e-mail can be sent to the technical support group at a computer software company. The term “people” is used throughout to more generally refer to all entities with which communications can occur, including entities that are not natural people. In addition, when “people” are described as known, it means that at least one of the various communication identifiers associated with them are known, whether or not the people/entities themselves are actually known.

A communication identifier is an identifier of the “person” used to communicate with the “person.” A communication identifier can be, for example, an address, such as an e-mail address, a screen name, or an internet protocol (IP) address, or it can be a number, such as a telephone number or a VoIP number. In one implementation, the communication identifiers are stored in the list of known people. Storing the communication identifiers in the list facilitates easy recognition of communications from a known person, thereby facilitating control over aspects of such communications based on whether the sender is known. Thus, the term “people” or “person” should be understood as having a meaning that includes any identifier of a person or organization.

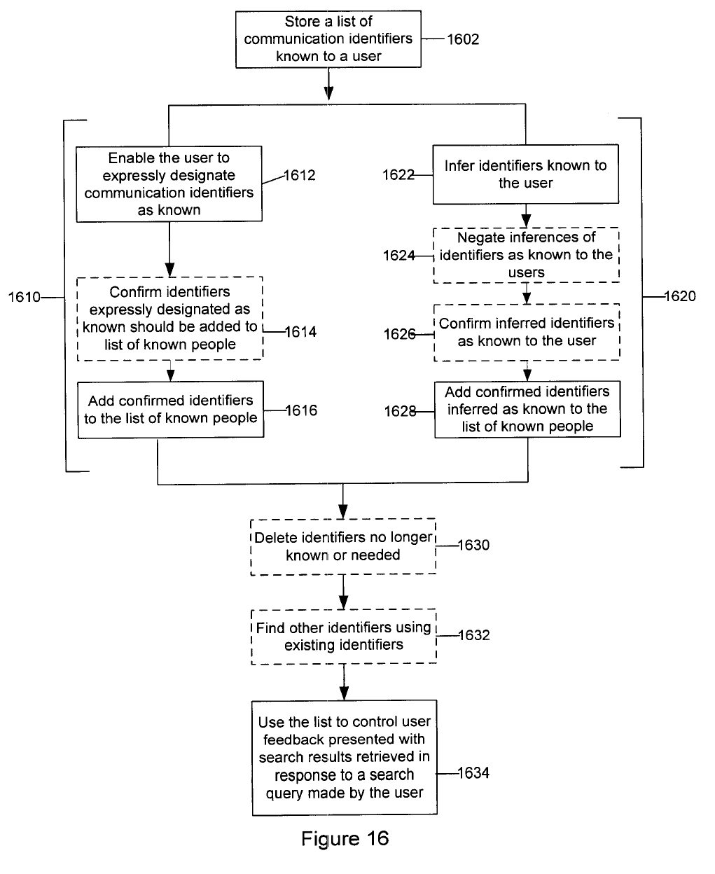

Referring to FIG. 16, a process 1600 is used to create, maintain and use the list of people known to the user. A list of people known to the user is stored (1602). Communication identifiers are stored in the list to indicate the known people.

The user may make manual additions to the list of known people (1610). To that end, the user is enabled to expressly designate communication identifiers as known (1612). For example, a graphical user interface (GUI) that allows the user to enter communication identifiers may be provided. There also may be a speech-based interface that allows the user to add communications identifiers to the list of known people by saying them. These interfaces may allow the user to augment the list of known people indirectly by allowing them to make additions to a contact list such as, for example, a custom sender list, an address book, or a buddy list.

However, the user may want to manually add a person to a contact list but not to the list of known people. An interface optionally may be presented to enable the user to confirm that the manually entered communication identifiers should be added to the list of known people (1614). The confirmation may be enabled by way of a graphical user interface that allows the user to select the entered communication identifiers that the user actually wants to be included in the list of known people. This confirmation may occur after a predetermined number of communication identifiers have been entered, or at login or logoff to seek confirmation of any people entered during the previous online session. Those identifiers that the user confirms may be added to the list (1616). When a confirmation interface is not presented, all entered communication identifiers are added to the list of known people. Alternatively, there may be an interface that allows the user to directly enter identifiers into the list of known people.

Communication identifiers also may be inferred as being known based on the actions of the user (1620). First, the communication identifiers known to the user are inferred (1622). For example, a communication identifier may be inferred as known if an e-mail message to that communication identifier is sent. When an instant messaging program is used, the communication identifier of the person with whom the user is communicating may be designated as known to the user.

Known communication identifiers may be inferred based on user interactions with a received message. For example, a communication identifier also may be inferred as known if a message from that communication identifier is read, replied to, forwarded, saved, or printed. Likewise, the communication identifier that sent the e-mail message may be designated as known if the message is moved from the “inbox” to a folder that is not marked for deletion or for spam, or if the message is left open for a predetermined amount of time.

Known communication identifiers also may be inferred based on indicia other than user actions. As an example, the people designated as known to the people the user knows may be designated as being “known” to the user. For instance, if a person B is designated as someone user A knows, then the people designated as known to person B also may be designated as “known” to user A. One way this may be implemented is, for example, to designate the people in an address book and/or buddy list of person B as known to user A.

When inferring known people, some actions may be taken into account to negate an inference that the person is known (1624). For instance, if an e-mail received from a person is forwarded to an e-mail address that has been designated for reporting spam, the inference that the user knows the person may be negated. As another example, an inference that a person is known may be negated if the person is included on an explicit black list of people with which communication should not occur. Such a black list may be created by the user or the network administrator.

After known communication identifiers are inferred, an interface optionally may be presented to enable the user to confirm that the inferred communication identifiers are in fact known (1626). The confirmation may be enabled by way of a graphical user interface that allows the user to select inferred communication identifiers that the user actually knows or wants to be included in the list of known people. This confirmation may occur after a predetermined number of communication identifiers have been inferred as known, or at login or logoff to seek confirmation of any people identified in the previous online session. Those identifiers that the user confirms may be added to the known people list (1628). When a confirmation interface is not presented, the inferred identifiers are added to the known people list.

Branches 1610 and 1620 may occur simultaneously or sequentially. After at least one of the branches has occurred, the user optionally may view the list of known people, and the user may delete users that are no longer known or needed (1630). In addition, communication identifiers in the list of known people can be used optionally to find other communication identifiers for that person (1632). For example, a person's e-mail address may be obtained from a profile associated with a screen name. Similarly, if the e-mail address is known, it may be used to obtain the screen name. The screen name, e-mail, or other determined communication identifiers may be used to determine other ways in which the known person may communicate with the user or in which the user may communicate with the known person.

At this point, the list can be used to control user feedback presented with search results retrieved in response to a search query made by the user (1634). For example, the known people list may be used to determine if an identity of a feedback-providing user is included in the known people list, and thus, whether the feedback-providing user is known to the searching user. Whether a feedback-providing user is known to a searching user may affect whether the user feedback provided by the feedback-providing user is presented to the searching user with a related search result.

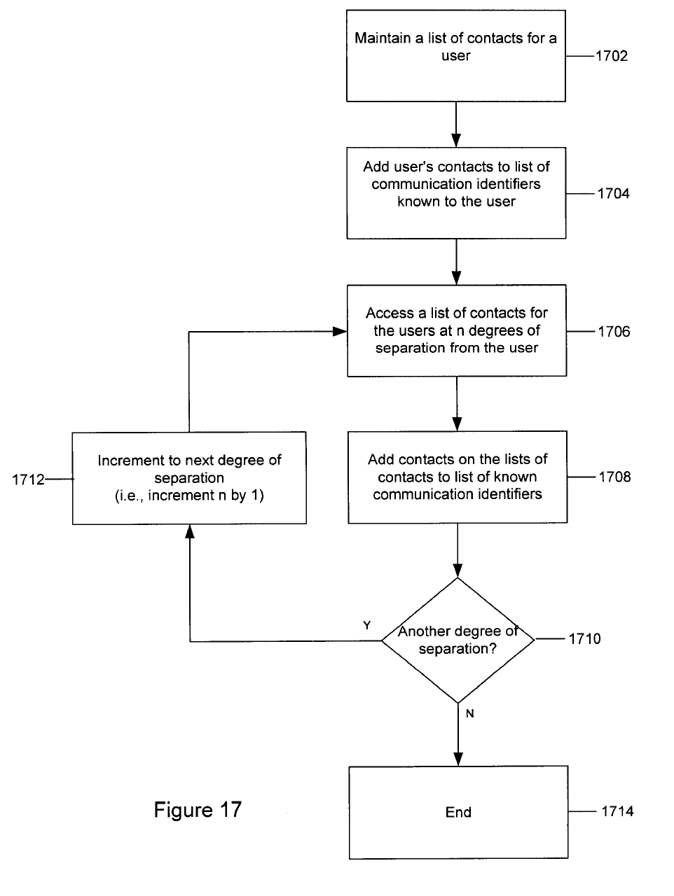

Referring to FIG. 17, a process 1700 may be used to infer people within a certain number of degrees of separation from the user as known to the user. The degree of separation between two entities describes a relationship between those entities. Typically, the characteristics of user contact lists (e.g., address book, buddy list, and/or white list) are evaluated to determine the number of degrees (or hops) that are required to link or relate two users.

For example, recipient A may list user B in recipient A's address book, user B may list user C in user B's address book, and user C may list sender D in user C's address book. Here, sender D is linked to recipient A by two degrees of separation (with user B as the first degree and user C as the second degree). Recipient A is related to user C by one degree of separation (user B) and user B is separated from sender D by one degree of separation (user C). Recipient A and user B, users B and C, and user C and sender D are each respectively separated by zero degrees of separation.

A list of contacts may be maintained for the user (1702). The list of contacts may be any personally maintained list or lists, such as, for example, an address book, a buddy list for instant messaging, and/or a white list. The rest of process 1700 will be described using an address book as an example of a list of contacts. The contacts in the user's address book may be added to the user's list of known people (1704).

The contacts linked to the user (i.e., up to a desired degree of separation) may be identified and added to the user's list of known people. To do so, the address books of each contact in the user's address book are accessed (1706). These address books are not normally configured for direct access by the user. That is, the user does not normally have access to other users' address books such as the address books of the contacts in the user's address book (the user's address book is configured for direct access by the user). The other users' address books typically include communication identifiers selected by the other users.

The contacts in the user's contacts' address books (i.e., the contacts separated by one degree) may be added to the list of known people (1708). If another degree of separation is desired (1710), the degree of separation is incremented (1712) such that the address books of the contacts that are separated from the user by one degree may be accessed (1706) and the contacts in those address books may be added to the list of known people list (1708). When a contact is added to the list of known people list, the contact's degree of separation from the user also may be added. The addition of contacts continues until the desired degree of separation is reached (1710). Once the desired degree of separation has been reached, all of the contacts within that desired degree of separation from the user have been inferred as known to the user (1714).

The desired degrees of separation may be a system parameter or, in some implementations, the user may be provided with the ability to set the desired degrees of separation. For example, the user may be provided with an interface that allows the user to decide whether degrees of separation will be used, and, if so, how many degrees should be used. Alternatively, the desired degrees of separation may be both a system parameter and a parameter that may be set by the user. For example, the system may include a default degrees of separation, which can be adjusted by the user if he or she so desires.

Process 1700 may result in the list of known people not being updated when any users related to the intended user update their contact lists. That is, if a user related to the intended user adds a contact to the user's contact list, the new contact may not be reflected in the intended user's list of known people. This situation may not be overly detrimental, particularly in implementations where the list of known people is used as a white list to exempt certain e-mails from spam filtering. However, repeating process 1700 on a periodic or aperiodic basis may mitigate this situation. Another manner of mitigating this situation is to use an update system in which changes to contact lists are tracked and lists of known people are updated accordingly in an incremental fashion or by triggering an update or re-initiation of process 1700 when an update occurs.

Many alternative methods may be used to indicate which people are known to a user. For example, known people can be expressly designated by putting them in a contact list. The contact list may be, for example, a white list, an address book, or an instant messaging buddy list. The people added to one or more of the contact lists may be added to the list of known people.

In addition, a custom sender list interface may allow for manual addition of communication identifiers to the list of known people through specification of a white list and a black list. A white list designates the communication identifiers of people known to the user. On the other hand, a black list designates the communication identifiers of people who are not known to the user. In some implementations, a black list also may designate the communication identifiers of people that the user wants to be treated like those who are not known to the user, for example, by blocking communications from those people as if the people were not known to the user. The custom sender list interface enables the user to expressly designate communication identifiers as known by adding them to the white list. The communication identifiers placed on the white list may be added to the list of known people.

An address book interface also may allow for manual addition of people to the list of known people through the addition of entries to an address book. Each entry in the address book contains information about a specific person, including the communication identifiers for that person. The address book interface enables the user to expressly designate communication identifiers as known by adding them to entries within the address book. The identifiers may be added to the list of known people. The address book interface may provide the user with an option for preventing the addition of communication identifier to the list of known people when the identifier is added to the address book. The option may prevent the addition for the identifier currently being added, or when the option is selected, may prevent all entered identifiers from being added to the list of known people.

A buddy list interface also may allow for manual addition of people to the list of known people through addition of screen names to a buddy list. A screen name is a communication identifier for a person in an instant messaging system. Messages are addressed to users of the instant messaging system using their screen names. The buddy list for a user of the instant messaging system is a list of screen names for people with which the user communicates. The buddy list interface enables the user to expressly designate communication identifiers as known by adding them to the user's buddy list. These identifiers may be added to the list of known people.

Additionally, or alternatively, which people are known to a user may be inferred from the actions of the user. For example, actions of the user while reading, sending and managing e-mail can lead to the inference that the people sending and receiving that e-mail are known to the user. In addition, the contacts of those people known to the user may be inferred to be known directly by the user. Inferred people may be added to the list of known people after an optional user confirmation.

Use of an e-mail reading interface may lead to the inference of people as known to the user. In using the e-mail reading interface, the user may perform certain actions while reading a message that signal that the user knows the person who sent the message. Conversely, the user may perform certain actions that signal that the user does not know the person who sent the message. If the sender of the e-mail is inferred to be known to the user based on these actions, the person who sent the e-mail is added to the list of known people.

The actions of the user while interacting with the e-mail reading interface may lead to the inference that the user knows or does not know the sender of the messages that the user is reading. In cases where the user is believed to know the sender of the message, the sender's e-mail address may be added to the list of known people. For example, replying to the message may support the inference that the sender is known. In addition, forwarding the message may support an inference that the sender, as well as all people to whom the message is forwarded, are known. Similarly, replying to all recipients and the sender may lead to an inference that the sender and all other recipients are known.

Creating an entry in the user's address book for the sender of the e-mail may lead to the inference that the sender is known. However, reporting the e-mail as spam may negate an inference that the sender is known to the user. Choosing to print, save, or marking the displayed message as not read also may support an inference that the sender is known.

Leaving the e-mail reading interface open for a predetermined period of time (e.g., 30 seconds) is another action that may support an inference that the sender is know.

A number of techniques may be used to determine when a sender is inferred as known based on the above described actions. For example, a sender may be inferred as known based simply on the user performing a single one of the actions that support an inference that the sender is known. Alternatively, or additionally, combinations of actions may result in the inference that the sender is known. For example, some number of actions greater than one may be required to add the sender to the list of known people. Also, certain fixed combinations of actions may result in the addition of the sender to the list of known people. That is, certain combinations may be designated as indicating that the communication identifier is known and, when those combinations occur, the identifier may be added to the list of known people. For example, replying to and saving an e-mail message may cause the sender to be added to the list of known people, but keeping the e-mail message as new and printing it may not.

As another example, each of the different possible actions may have an associated score indicative of how strongly the action suggests the identifier is known, and a certain aggregate score (a threshold score) may be required to add the sender to the list of known people. That is, the actions may be detected, an aggregate score may be determined from the associated scores, and a comparison to a threshold score may be made to infer whether the person is known to the user and, consequently, may be added to the list of known people. An implementation of this technique may assign positive scores to actions supporting an inference, assign negative scores to actions negating an inference, and require a particular positive aggregate score before the identifier may be inferred as known. Other methods of combining the actions of the user to infer that the sender is known to the user may be employed.

When replying to all recipients and the sender of an e-mail message, all recipients of the message may not be known, especially when there is a large number of people to whom the original message was copied. Additional actions may be required to show that the people to whom the message was copied are known even though a message is sent to them, which might normally lead to the inference that the people are known. The number of people to whom the original message was copied may influence the number or combinations of actions further needed to add the copied recipients to the list of known people.

Use of an e-mail writing interface also may lead to people being added to the list of known people. In using the e-mail writing interface, the user may perform certain actions while writing a message that may signal that the user knows the people to whom the message will be sent. If the recipients of the e-mail are inferred to be known to the user, the recipients may be added to the list of known people.

For example, sending the message that is being written leads to the inference that the recipients of the message are known. Likewise, printing the message leads to the inference that the intended recipients are known. In addition, an address book interface may be invoked while using the e-mail writing interface and may be used to manually add entries to the address book, which will result in additions to the list of known people, as was described above.

If the recipients are inferred to be known, the recipients may be added to the list of known people. Individual actions of the user while using the e-mail writing interface that lead to the inference that the recipients are known may cause the recipients to be added to the list of known people, or a combination of actions may signal that the recipients may be added to the list of known people, as was described above.

The e-mail reading interface and the e-mail writing interface also may contain a button that enables the user to manually add the people with whom the user is communicating to the list of known people if the people are not added automatically in the manners described above. For example, clicking on such a button in the e-mail reading interface may cause the sender of the message to be added to the list of known people. Likewise, clicking on such a button in the e-mail writing interface would cause the recipient of the e-mail to be added to the list of known people.

The actions of the user while interacting with an e-mail managing interface also may lead to the inference that certain people are known to the user. Conversely, the user may perform certain actions while using the e-mail managing interface that signal that the user does not know certain people. If people are inferred as known to the user from these actions, the people are added to the list of known people.

Two main components of the e-mail managing interface are a folder list and a message list. The folder list may contain different folders into which messages can be filed. When a folder is selected from the folder list, its contents are listed in the message list.

The user's actions while using folders, messages, and buttons present in the e-mail managing interface may result in the addition of people to the list of known people. Moving a message between the different folders of the folder list may lead to the inference that the sender or recipients of the message are known. For example, dragging a message from a “New” folder to another folder, except for a spam or delete folder, may result in the inference that the sender of message is known to the user. Opening a message may support an inference that the sender of the message is known. Saving a message or marking the message as unread also may result in the inference that the sender of the message is known to the user. However, deleting a message or reporting the message as spam may negate an inference that the senders or recipients are known to the user. Individual actions or a combination of actions when using the e-mail managing interface may lead to the inference that people are known to the user. Those people that are inferred to be known to the user may be added to the list of known people after an optional confirmation by the user.

A number of implementations have been described. Nevertheless, it will be understood that various modifications may be made without departing from the spirit and scope of the claims. For example, the terms web page and web site are used throughout for clarity of description. However, the characteristics of any data resource may be displayed to provide a better understanding of the contents of the data resource. A data resource is any local or remote resource that satisfies the search criteria entered.

As another example, similar methodologies of describing the characteristics of content accessible with a link may be used for any link that is displayed or encountered, even those presented outside the context of a search environment. For example, any web page or e-mail message that includes or references a link also would show a description of the characteristics of content that may be accessed with the link. In such a case, the description of the characteristics of the content may be done by the provider (i.e., publisher) of the content.

The described systems, methods, and techniques may be implemented in digital electronic circuitry, computer hardware, firmware, software, or in combinations of these elements. Apparatus embodying these techniques may include appropriate input and output devices, a computer processor, and a computer program product tangibly embodied in a machine-readable storage device for execution by a programmable processor. A process embodying these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

In addition, useful results still could be achieved if steps of the disclosed techniques were performed in a different order and/or if components in the disclosed systems were combined in a different manner and/or replaced or supplemented by other components. As another example, a screen name is used throughout to represent a unique identifier of an account, but any other unique identifier of an account may be used when linking accounts. Accordingly, other implementations are within the scope of the following claims.

What is claimed is:

1. A method, performed at least partially on a computer, for displaying user feedback for a search result, the method comprising:
receiving a search query from a query submitter; and
accessing a relevancy rating that is derived from feedback received from a user other than the query submitter and that reflects how the other user perceived relevancy of the search result to the search query.

2. The method of claim 1 further comprising:
comparing the accessed relevancy rating for a search result with relevancy ratings related to other search results; and
sorting the search results based on the comparison.

3. The method of claim 1 further comprising displaying the relevancy rating for user perception in the form of at least one of raw, numeric or symbolic data.

4. The method of claim 1 wherein relevancy of the search result to the search query is determined based on relevancy of the search result to words related to the search query.

5. The method of claim 1 wherein relevancy of the search result to the search query is determined based on relevancy of words that are related to words appearing in the search result to words in the search query.

6. The method of claim 1 wherein relevancy of the search result to the search query is determined based on relevancy of words that are related to words appearing in the search result to words related to words in the search query.

7. The method of claim 1 wherein the relevancy rating is accessed if it is derived from feedback received from a user who belongs to a subset of user identities determined to be known to the query submitter.

8. The method of claim 7 wherein user identities are determined to be known to the query submitter if at least one of the user identities is within a particular degree of separation from the query submitter, the user identities exist in at least one of a contact list, co-user list or white list belonging to the query submitter, or the user identities share attributes with the query submitter.

9. A method, performed at least partially on a computer, for receiving relevancy feedback related to a search query, the method comprising:
providing a search result responsive to a search query submitted by a feedback-providing user;
soliciting and receiving relevancy feedback that reflects how the feedback-providing user perceived relevancy of the search result to the search query; and
aggregating the relevancy feedback with other relevancy feedback received for the same search result provided in response to a related search query.

10. The method of claim 9 wherein the related search query includes a search query that is identical to the search query submitted by the feedback-providing user.

11. The method of claim 9 wherein the related search query includes a search query having at least one word in common with the search query submitted by the feedback-providing user.

12. The method of claim 9 wherein the related search query includes a search query having the same meaning as the search query submitted by the feedback-providing user.

13. The method of claim 9 wherein the related search query includes a search query related to the same topic as the search query submitted by the feedback-providing user.

14. The method of claim 9 wherein receiving relevancy feedback includes enabling the feedback-providing user to rate the relevancy of the search result to the search query via a user interface enabled to display the search result and receive the relevancy rating.

15. The method of claim 9 wherein the relevancy rating is at least one of a numeric ranking, a selection of a pre-determined comment, or creation of a user-created comment related to the relevancy of the search result to the search query.

16. The method of claim 9 wherein aggregating the relevancy feedback with other relevancy feedback received for the same search result provided in response to a related search query includes creating and storing a relevancy feedback table.

17. The method of claim 16 wherein the relevancy feedback table includes a search query, at least one related search query, at least one search result that is responsive to the search query, and relevancy feedback for the search result.

18. The method of claim 16 wherein the relevancy table further includes an identity of a feedback-providing user who provided the relevancy feedback for the search result and a list of attributes related to the feedback-providing user.

19. An apparatus for displaying user feedback for a search result, the apparatus being configured to:
receive a search query from a query submitter; and
access a relevancy rating that is derived from feedback received from a user other than the query submitter and that reflects how the other user perceived relevancy of the search result to the search query.

20. An apparatus for receiving relevancy feedback related to a search query, the apparatus being configured to:
provide a search result responsive to a search query submitted by a feedback-providing user;
solicit and receiving relevancy feedback that reflects how the feedback-providing user perceived relevancy of the search result to the search query; and
aggregate the relevancy feedback with other relevancy feedback received for the same search result provided in response to a related search query.
